(19) United States
(12) Patent Application Publication
(10) Pub. No.: US 2015/0312508 A1
(43) Pub. Date: Oct. 29, 2015

(54) USER TERMINAL DEVICE, METHOD FOR CONTROLLING USER TERMINAL DEVICE AND MULTIMEDIA SYSTEM THEREOF

(71) Applicant: SAMSUNG ELECTRONICS CO., LTD., Suwon-si (KR)

(72) Inventors: Joon-ho PHANG, Seoul (KR); Chang-seog KO, Hwaseong-si (KR); Jae-ki KYOUN, Seoul (KR); Kwan-min LEE, Seoul (KR)

(73) Assignee: SAMSUNG ELECTRONICS CO., LTD., Suwon-si (KR)

(21) Appl. No.: 14/697,726

(22) Filed: Apr. 28, 2015

(30) Foreign Application Priority Data
Apr. 28, 2014 (KR) 10-2014-0050836

(51) Int. Cl. H04N 5/44; G06F 3/01; H04N 5/445; G06F 3/0488; G06F 3/041; G06F 3/0484

(52) U.S. Cl. CPC H04N 5/4403; G06F 3/041; G06F 3/04845; H04N 5/44513; G06F 3/0488; G06F 3/017; H04N 2005/443; G06F 2203/04104

(57) ABSTRACT

A user terminal device, a method for controlling the user terminal device, and a multimedia system for controlling an external display device to seamlessly display image contents displayed on the user terminal device.

### CROSS-REFERENCE TO RELATED APPLICATION

This application claims priority from Korean Patent Application No. 10-2014-0050836, filed in the Korean Intellectual Property Office on Apr. 28, 2014, the disclosure of which is incorporated herein by reference in its entirety.

### BACKGROUND

1. Field

Aspects of the exemplary embodiments relate to a user terminal device, a method for controlling the user terminal device, and a multimedia system thereof, and more particularly, to a user terminal device that allows a user to simultaneously view content displayed on a display apparatus, a method for controlling the user terminal device, and a multimedia system thereof.

2. Description of the Related Art

Currently, a display apparatus may display various content to a user. A user may wish to simultaneously view multiple contents and select a desired content from among the multiple contents.

Conventionally, a user may simultaneously view multiple contents using a Picture In Picture (PIP) function, but when the PIP function is used, an image of one of the contents may obscure an image of another of the contents, thereby interrupting the user from continuously viewing an entirety of the currently displayed image content.

In addition, it is difficult to simultaneously control an original, currently viewed image and a PIP image using a single remote controller.

Alternatively, a user may simultaneously view multiple contents using a plurality of display apparatuses. For example, a user may view image contents using a TV and a smart phone. However, in this case, a plurality of display apparatuses may not operate in conjunction with each other, so the user must individually and independently control the plurality of display apparatuses.

### SUMMARY

Aspects of the exemplary embodiments relate to a user terminal device that allows a user to view content currently displayed on a display apparatus so that the user may more intuitively control the display apparatus, a method for controlling the user terminal device, and a multimedia system thereof.

According to an aspect of an exemplary embodiment, there is provided a user terminal device including a display configured to display at least one first image contents displayed on an external display apparatus, a user interface configured to detect a user input on the display, a controller configured to display at least one second image contents having different number of image contents from a number of the first image contents on the display in response to the user interface detecting the user input, and a transceiver configured to transmit to the external display apparatus identification information identifying at least one of the second image contents to control the external display apparatus to display the at least one of the second image contents.

According to an aspect of an exemplary embodiment, there is provided a multimedia system including a display apparatus and a user terminal device, the display apparatus including a display configured to display at least one first image contents, a transceiver configured to transmit the first image contents, and the user terminal device includes a transceiver configured to receive the first image contents from the display apparatus, a display configured to display the first image contents received by the transceiver, a user interface configured to detect a user input on the display of the user terminal device, a controller configured to control the display of the user terminal device to display at least one second image contents having different number of image contents from the first image contents, in response to the user interface detecting the user input, and, wherein the transceiver is further configured to transmit to the display apparatus information identifying at least one image content of the second image contents to control the display apparatus to display the at least one image content of the second image contents on the display of the display apparatus.

According to an aspect of an exemplary embodiment, there is provided a method for controlling an external display apparatus of a user terminal device, the method including displaying on a display of the user terminal device at least one first image contents displayed on a display of the external display apparatus, detecting a user input on the display of the user terminal device, displaying at least one second image contents having different number of image contents from a number of the first image contents on the display of the user terminal device, in response to detecting the user input on the display of the user terminal device, and transmitting to the external display apparatus identification information identifying at least one image content of the second image contents to control the external display apparatus to display the at least one of the second image contents on the display of the external display apparatus.

According to an aspect of an exemplary embodiment, there is provided a method for controlling a multimedia system including a display apparatus and a user terminal device, the method including, displaying at least one first image contents on a display of the display apparatus, and transmitting the first image contents to the user terminal device, receiving the first image contents from the display apparatus at the user terminal device, displaying the first image contents image contents on a display of the user terminal device, detecting a user input on the display of the user terminal device, displaying a second image contents having different number of image contents from a number of the first image contents on the display of the user terminal device, transmitting to the display apparatus identification information identifying at least one image content of the second image contents , and displaying the at least one image content of the second image contents on the display of the display apparatus based on the identification information.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a view illustrating a multimedia system according to an exemplary embodiment;

FIG. 2 is a block diagram illustrating configuration of a user terminal device briefly according to an exemplary embodiment;

FIG. 3 is a block diagram illustrating configuration of a user terminal device according to an exemplary embodiment;

FIGS. 4A to 4E are views illustrating a method of changing the number of image contents displayed on a user terminal device according to an exemplary embodiment;

FIGS. 5A to 5G are views illustrating a method of changing the number of image contents displayed on a user terminal device according to another exemplary embodiment;

FIGS. 6A to 6G are views illustrating a method of changing the number of image contents displayed on a user terminal device according to another exemplary embodiment;

FIGS. 7A to 7E are views illustrating a method of changing the number of image contents displayed on a user terminal device according to another exemplary embodiment;

FIGS. 8A to 8B are views illustrating a method of changing the number of image contents displayed on a user terminal device according to another exemplary embodiment;

FIGS. 9A to 9F are views illustrating a method of changing the number of image contents displayed on a user terminal device according to another exemplary embodiment;

FIGS. 10A to 10D are views illustrating a method of displaying an image content displayed on a user terminal device on a display apparatus according to an exemplary embodiment;

FIGS. 11A to 11C are views illustrating a method of displaying an image content displayed on a user terminal device on a display apparatus according to another exemplary embodiment;

FIGS. 12A to 12C are views illustrating a method of displaying an image content displayed on a user terminal device on a display apparatus according to another exemplary embodiment;

FIG. 13 is a block diagram illustrating configuration of a display apparatus according to an exemplary embodiment;

FIG. 14 is a flowchart illustrating a method through which a user terminal device controls a display apparatus according to an exemplary embodiment;

FIG. 15 is a flowchart illustrating a method through which a user terminal device controls a display apparatus according to another exemplary embodiment;

FIG. 16 is a flowchart illustrating a method through which a user terminal device controls a display apparatus according to another exemplary embodiment; and

FIG. 17 is a flowchart illustrating a method through which a user terminal device controls a display apparatus according to another exemplary embodiment.

### DETAILED DESCRIPTION OF EXEMPLARY EMBODIMENTS

The exemplary embodiments may vary, and may be differently provided. Specific exemplary embodiments will be described with reference to accompanying drawings and detailed explanation. However, this does not necessarily limit the scope of the exemplary embodiments to a specific embodiment form. Instead, modifications, equivalents and replacements included in the disclosed concept and technical scope of this specification may be employed. While describing exemplary embodiments, if it is determined that the specific description regarding a known technology obscures detailed description, the specific description is omitted.

In the present disclosure, relational terms, such as first and second, and the like, may be used to distinguish one entity from another entity, without necessarily implying any actual relationship or order between such entities.

The terms used in the following description are provided to explain a specific exemplary embodiment and are not intended to limit the scope of rights. A singular term includes a plural form unless it is intentionally written that way. The terms, “include”, “comprise,” “is configured to,” etc. of the description are used to indicate that there are features, numbers, steps, operations, elements, parts or combination thereof, and should not exclude the possibilities of combination or addition of one or more features, numbers, steps, operations, elements, parts, or combination thereof.

In an exemplary embodiment, ‘a module’ or ‘a unit’ performs at least one function or operation, and may be realized as hardware, software, or combination thereof. In addition, a plurality of ‘modules’ or a plurality of ‘units’ may be integrated into at least one module and may be realized as at least one processor or microprocessor except for ‘modules’ or ‘units’ that should be realized in a specific hardware.

Expressions such as “at least one of” do not necessarily modify an entirety of a following list and do not necessarily modify each member of the list, such that “at least one of a, b, and c” should be understood as including only one of a, only one of b, only one of c, or any combination of a, b, and c.

Hereinafter, various exemplary embodiments will be described in detailed with reference to accompanying drawings.

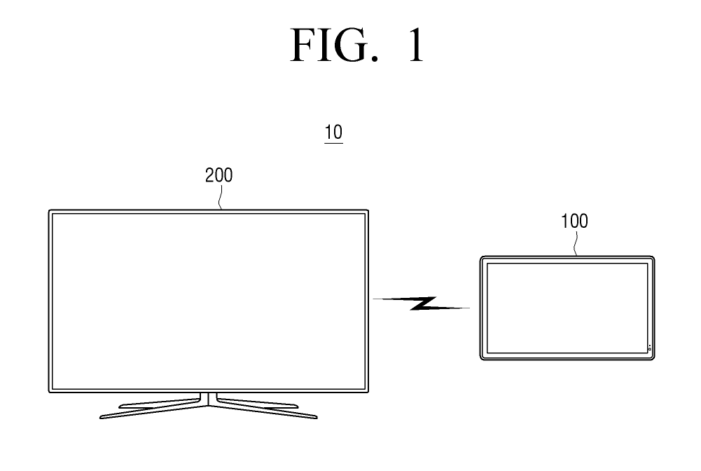

FIG. 1 is a view illustrating a multimedia system 10 according to an exemplary embodiment. As illustrated in FIG. 1, the multimedia system 10 includes a user terminal device 100 and a display apparatus 200. In this case, the user terminal device 100 may be a remote controller having a touch screen and being configured to control the display apparatus 200, but this is only an example. The user terminal device 100 may be realized as any portable user terminal, such as smart phone, tablet PC, etc. In addition, the display apparatus 200 may be a smart TV, but this is only an example. The display apparatus 200 may be realized as any display apparatus, such as digital TV, desktop PC, notebook PC, etc.

The user terminal device 100 and the display apparatus 200 may be connected to each other through various wired or wireless communication methods. For example, the user terminal device 100 and the display apparatus 200 may wirelessly communicate with each other using a wireless communication module and wireless communication protocol, such as Bluetooth, WiFi, etc.

In addition, the user terminal device 100 and the display apparatus 100 may display image content, respectively. In this case, the image content displayed by the user terminal device 100 may be received from the display apparatus 200, but this is only an example. The image content displayed by the user terminal device 100 may be received from a separate external apparatus or may be a stored image content. The image content may be broadcast content, but this is only an example. The image content may be video on demand (VOD) image content received from Internet, a stored image content, etc.

If a user interaction is detected, the user terminal device 100 may transmit to the display apparatus 200 a signal requesting content. In this case, the user interaction may be a drag interaction on the user terminal device 100 , for example touching an upper area of the user terminal device 100 and dragging in a lower direction.

If the image content currently displayed by the display apparatus 200 is transmitted from the display apparatus 200 and received by the user terminal device 100, the user terminal device 100 may display the received image content. For example, if the display apparatus 200 displays multiple image contents, the user terminal device 100 may receive the multiple image contents from the display apparatus 200 and display the multiple image contents.

If a predetermined user interaction is detected on a touch screen of the user terminal device 100, the user terminal device 100 may display multiple image contents which are different from the received image contents. For example, the user terminal device 100 may display a subset of the received image contents.

If a user interaction is detected while the different image contents are displayed, the user terminal device 100 may transmit information indicating or selecting at least one image content from among the different image contents to the display apparatus 200. If the information indicating or selecting the at least one image content is received by the display apparatus 200 from the user terminal device 100, the display apparatus 200 may display at least one image content corresponding to the received information.

By using the multimedia system 100 described above, a user may more intuitively control the display apparatus 200 using the user terminal device 100, and simultaneously watch various image contents using the user terminal device 100 and the display apparatus 200.

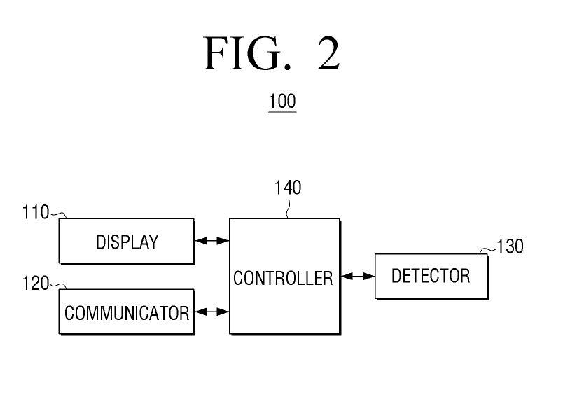

FIG. 2 is a block diagram illustrating configuration of the user terminal device 100 according to an exemplary embodiment. As illustrated in FIG. 2, the user terminal device 100 includes a display 110, a communicator 120, a detector 130, and a controller 140.

The display 110 displays various image contents under the control of the controller 140. In particular, the display 110 may display an image content received from the display apparatus 200. For example, if an image stream of first image content is received from the display apparatus 200, the display 110 displays the first image content, and if an image stream having multiple multiplexed image contents is received, the display 110 may simultaneously display the multiple image contents.

Meanwhile, the display 110 may be realized as a touch screen in combination with a touch detector of the detector 130.

The communicator 120 communicates with various external apparatuses. In particular, the communicator 120 may communicate with the display apparatus 200. In this case, the communicator 120 may receive an image content from the display apparatus 200 in real time, and transmit to the display apparatus 200 a content request signal for requesting an image content.

The detector 130 detects a user interaction to control the user terminal device 100. In particular, the detector 130 may be provided within a touch screen and realized as a touch detector capable of detecting a user interaction (for example, a touch or drag interaction).

The controller 140 controls overall operations of the user terminal device 100.

If a user interaction is detected through the detector 130 while the display apparatus 200 displays multiple image contents, the controller 140 may control the communicator 120 to transmit to the display apparatus 200 a signal for requesting the multiple image contents. The display apparatus 200 may generate an image stream by multiplexing the multiple image contents and transmit the generated image stream to the user terminal device 200. The user terminal device 100 may demultiplex the multiple image contents from the received image stream and simultaneously display the image contents on the display.

If the user terminal device 100 displays the multiple image contents, the controller 140 may control the display 110 to synchronize and display the multiple image contents displayed by the display apparatus 200 using timestamp information included in metadata of the multiple image contents. Accordingly, the user terminal device 100 may view the image content currently displayed by the external display apparatus 200.

If a user interaction is detected through the detector 130 while the multiple image contents received from the display apparatus 200 are displayed on the display 110, the controller 140 may control the display 110 to display one or more image contents different from the received image contents.

While the one or more image contents are displayed on the display 110, the controller 140 may control the communicator 110 to transmit information regarding at least one of the one or more image contents to the display apparatus 200 so that at least one of the one or more image contents is also displayed on the display apparatus 200. Specifically, if a touch drag interaction of touching a first image content from among the one or more image contents and dragging the touched image content in an upper direction is detected through the detector 130, the controller 140 may control the communicator 120 to transmit information regarding the first image content to the display apparatus 200. If the information regarding the first image content is received, the display apparatus 200 may display the first image content on the display screen.

In addition, if a drag interaction of touching a border line between the first image content and a second image content from among the one or more image contents and dragging the touched line in an upper direction is detected through the detector 130, the controller 140 may control the communicator 120 to transmit information regarding the first image content and the second image content to the display apparatus 200. If the information regarding the first image content and the second image content is received, the controller 140 may simultaneously display the first image content and the second image content on the display screen.

In addition, if no user interaction is detected through the detector 140 for a predetermined time after the one or more image contents received from the display 200 are displayed on the display 110, the controller 140 may control the communicator 110 to transmit information regarding the one or more image contents to the display 200 so that the one or more image contents are displayed on the display apparatus 200.

Through the above-described process, a user may control the display apparatus 200 to display an image that the user watches on the user terminal device 100.

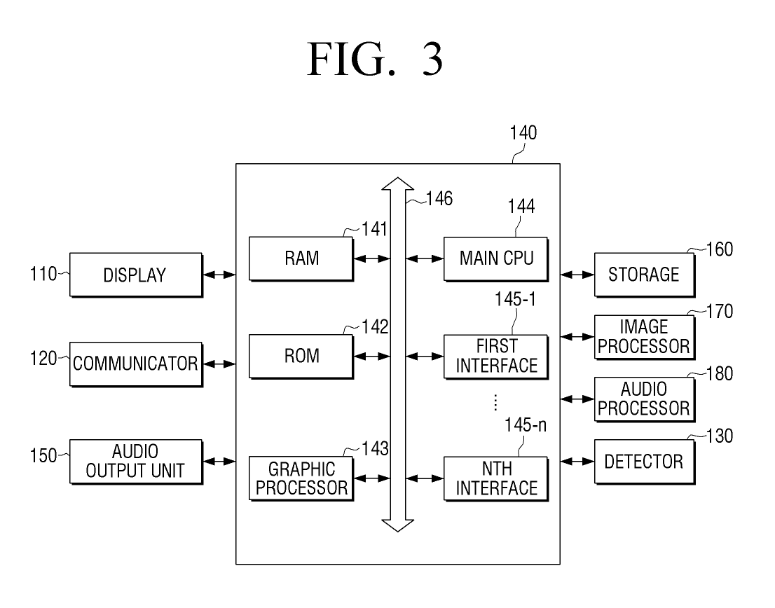

FIG. 3 is a block diagram illustrating configuration of the user terminal device 100 in according to an exemplary embodiment. As illustrated in FIG. 3, the user terminal device 100 includes the display 110, the communicator 120, an audio output unit 150, a storage 160, an image processor 170, an audio processor 180, the detector 130, and the controller 140.

Meanwhile, FIG. 3 comprehensively illustrates various components, assuming that the user terminal device 100 is an apparatus having various functions, such as contents providing function, display function, communication function, etc. Accordingly, depending on exemplary embodiments, a part of the components illustrated in FIG. 3 may be omitted or changed, or other components may be added.

The display 110 displays at least one of a video frame generated as the image processor 170 processes image data received through the communicator 120 and various screens generated by a graphic processor 143. In particular, the display 110 may display at least one broadcast content received from the external display apparatus 200. Specifically, if an image stream including a broadcast content is received, the display 110 may display a broadcast content processed by the image processor 170. In addition, if an image stream having multiple multiplexed broadcast contents is received, the display 110 may simultaneously display the multiple broadcast contents demultiplexed by the image processor 170.

The communicator 120 performs communication with various types of external apparatuses according to various types of communication methods. The communicator 120 may include a WiFi chip, a Bluetooth chip, a Near Field Communication (NFC) chip, and a wireless communication chip. In this case, the WiFi chip, the Bluetooth chip, and the NFC chip performs communication according to a WiFi method, a Bluetooth method, and an NFC method, respectively. The NFC chip represents a chip which operates according to an NFC method which uses 13.56 MHz band among various RF-ID frequency bands such as 135 kHz, 13.56 MHz, 433 MHz, 860-960 MHz, 2.45 GHz, and so on. In the case of the WiFi chip or the Bluetooth chip, various connection information such as SSID and a session key may be transmitted/received first for communication connection and then, various information may be transmitted/received. The wireless communication chip represents a chip which performs communication according to various communication standards such as IEEE, Zigbee, 3^{rd} Generation (3G), 3^{rd} Generation Partnership Project (3GPP), Long Term Evolution (LTE) and so on.

In particular, the communicator 120 may receive an image stream including a broadcast content from the display apparatus 200. In addition, the communicator 120 may transmit information regarding an image content that a user wishes to watch through the display apparatus 200 to the display apparatus 200 according to a user interaction.

In addition, the communicator 120 may receive various image contents, such as a VOD content from an external server.

The audio output unit 150 outputs not only various audio data processed in many ways, such as decoding, amplification, and noise filtering by the audio processor 180, but also various alarm sounds or voice messages. In particular, if the display apparatus 200 displays a plurality of image contents, the audio output unit 150 may output an audio corresponding to an image content selected by a user from among the plurality of image contents.

The storage 160 stores various modules to control the user terminal device 100. For example, the storage 160 may store software including a base module, a sensing module, a communication module, a presentation module, a web browser module, and a service module. In this case, the base module refers to a basic module that processes a signal transmitted from each hardware included in the user terminal device 100, and transmits the processed signal to an upper layer module. The sensing module is a module that collects information from various sensors, and analyzes and manages the collected information. The sensing module may include a face recognition module, a voice recognition module, a motion recognition module, and an NFC recognition module, and so on. The presentation module is a module to compose a display screen. The presentation module includes a multimedia module for reproducing and outputting multimedia contents, and a UI rendering module for UI and graphic processing. The communication module is a module to perform communication with outside. The web browser module refers to a module that accesses a web server by performing web-browsing. The service module is a module including various applications for providing various services.

As described above, the storage 160 may include various program modules, but some of the various program modules may be omitted or changed, or new modules may be added according to the type and characteristics of the user terminal device 100. For example, if the user terminal device 100 is realized as a smart phone, the base module may further include a location determination module to determine a GPS-based location, and the sensing module may further include a sensing module to detect a user's operation.

In addition, the storage 160 may include a buffer that temporarily stores an image content so that the user terminal device 100 and the display apparatus 200 synchronize and reproduce the image content. The image content stored in the buffer may be output to the display 110 according to timestamp information of the image content.

The image processor 170 processes an image stream including an image content received through the communicator 120. The image processor 170 may perform various image processing with respect to an image stream, such as decoding, de-multiplexing, scaling, noise filtering, frame rate conversion, resolution conversion, etc.

The audio processor 180 processes audio data of image contents. The audio processor 180 may perform various processing, such as decoding, amplification, noise filtering, etc. with respect to audio data. The audio data processed by the audio processor 180 may be output to the audio output unit 150.

The detector 130 may detect various user interactions to control configuration of the user terminal device 100. In particular, the detector 130 may be realized as a touch detector to detect a user's touch interaction. In this case, the touch detector may be disposed on the rear side of the display 110 and realized as a touch screen.

The controller 140 controls overall operations of the user terminal device 100 using various programs stored in the storage 160.

As illustrated in FIG. 3, the controller 140 includes a random access memory (RAM) 141, a read only memory (ROM) 142, a graphic processor 143, a main central processing unit (CPU) 144, a first to an nth interface 145-1-145-n, and a bus 146. In this case, the RAM 141, the ROM 142, the graphic processor 143, the main CPU 144, the first to the nth interface 145-1-145-n, etc. may be interconnected through the bus 146.

The ROM 142 stores a set of commands for system booting. If a turn-on command is input and thus, power is supplied, the main CPU 144 copies operating system (O/S) stored in the storage 160 in the RAM 141 according to a command stored in the ROM 142, and boots a system by executing the O/S. When the booting is completed, the main CPU 144 copies various application programs stored in the storage 160 in the RAM 141, and executes the application programs copied in the RAM 141 to perform various operations.

The graphic processor 143 generates a screen including various objects, such as a pointer, an icon, an image, a text, etc. using an computing unit and a rendering unit. The computing unit computes property values such as coordinates, shape, size, and color of each object to be displayed according to the layout of the screen using a control command received from an input unit. The rendering unit generates a screen with various layouts including objects based on the property values computed by the computing unit. The screen generated by the rendering unit is displayed in a display area of the display 110.

The main CPU 144 accesses the storage 160, and performs booting using the O/S stored in the storage 160. The main CPU 144 performs various operations using various programs, contents, data, etc. stored in the storage 160.

The first to the nth interface 145-1-145-n are connected to the above-described various elements, and may include a network interface connected to an external apparatus via a network.

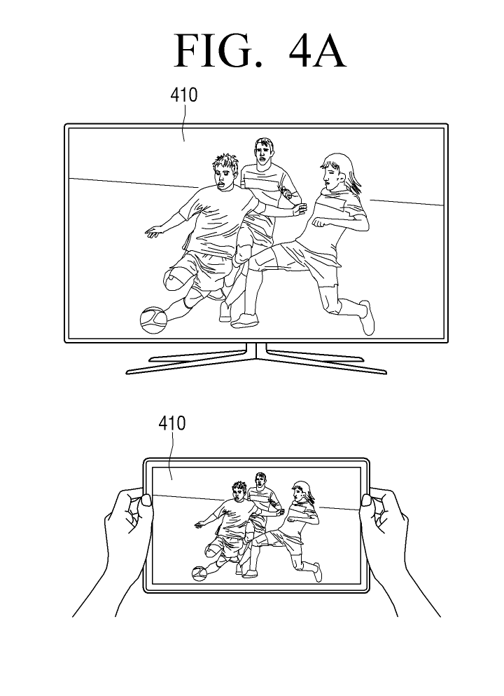

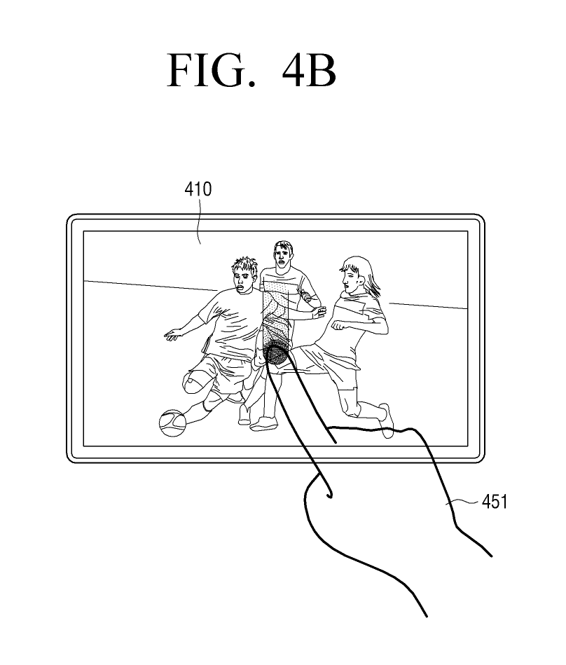

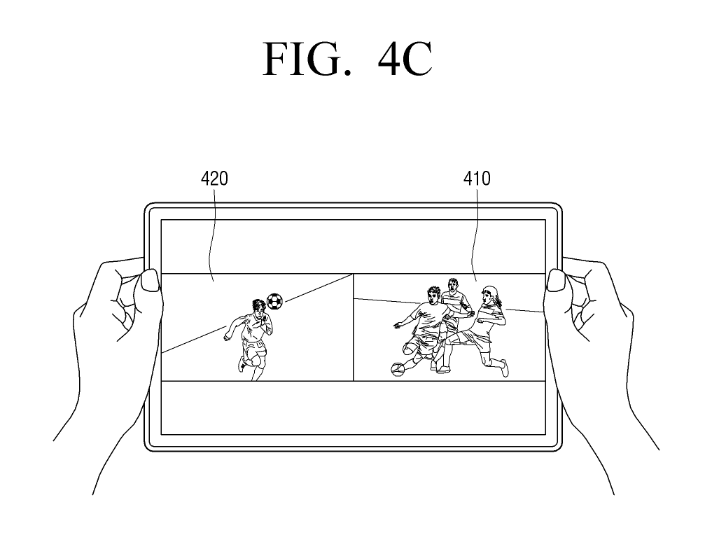

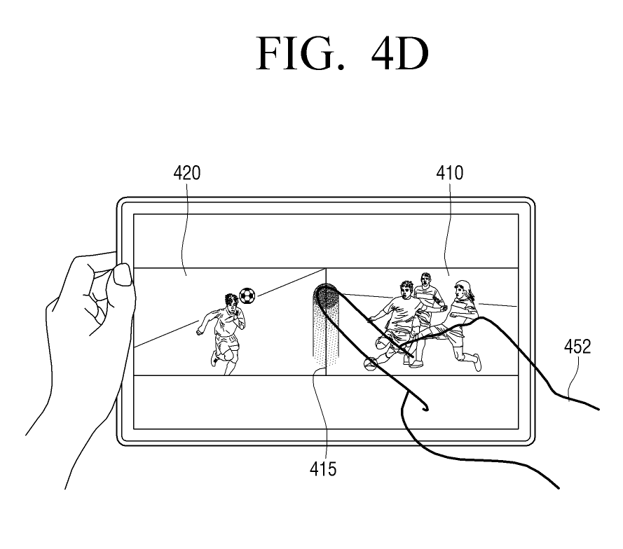

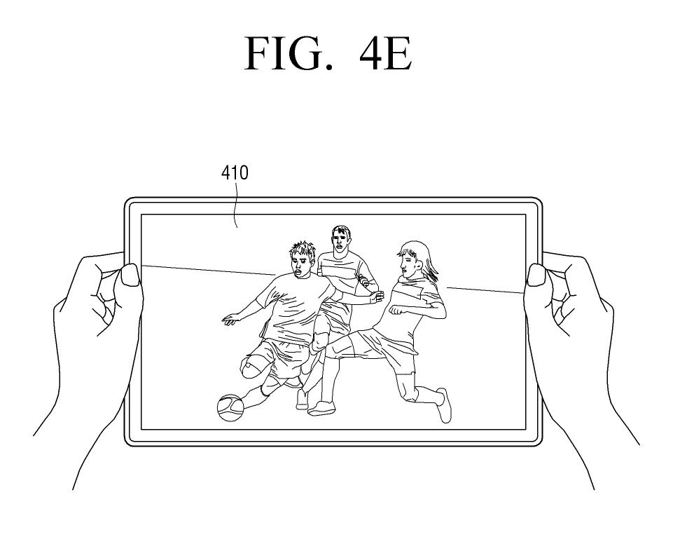

Hereinafter, the function of the controller 140 will be described in greater detail with reference to FIGS. 4A to 12C.

FIGS. 4A to 4E are views illustrating a method of changing the number of image contents displayed on the user terminal device 100 according to an exemplary embodiment.

Referring to FIG. 4A, the display apparatus 200 may display a first image content 410, and the controller 140 may control to display the first image content 410 on the display 110. In this case, the controller 140 may control the communicator 120 to receive the first image content from the display apparatus 200 or an external server.

Referring to FIG. 4B, while the first image content is displayed on the display 110, the detector 130 may detect a touch drag interaction 451 of touching an upper-end point of the first image content 410 and dragging the touched point in a lower direction.

Referring to FIG. 4C, in response to the touch drag interaction 451, the controller 140 may resize and reposition the first image content 410 on one side of a trace corresponding to the touch drag interaction and display a second image content 420 on the other side of the trace. In this case, the second image content 420 may be received from the display apparatus 200 or an external server.

Referring to FIG. 4D, while the first image content 410 and the second image content 420 are displayed on the display 110, the detector 130 may detect a touch drag interaction 452 of touching a point below a border line 415 between the first image content 410 and the second image content 420 and dragging the touched point in an upper direction.

Referring to FIG. 4E, in response to the touch drag interaction 452, the controller 140 may remove one of the first image content 410 and the second image content 420 displayed on the display 110. The image content to be removed, for example, may be an image content which is displayed most recently in time or least recently in time. As a result, the controller 140 may resize and reposition the first image content 410 and display the image on an entire area of the display 110.

Meanwhile, referring to FIGS. 4A to 4C, the first image content 410 previously displayed and the second image content 420 generated by the touch drag interaction 451 are the same in size, but this is only an example. The ratio of the first image content 410 and the second image content 420 may vary according to the location of the touch drag interaction 451.

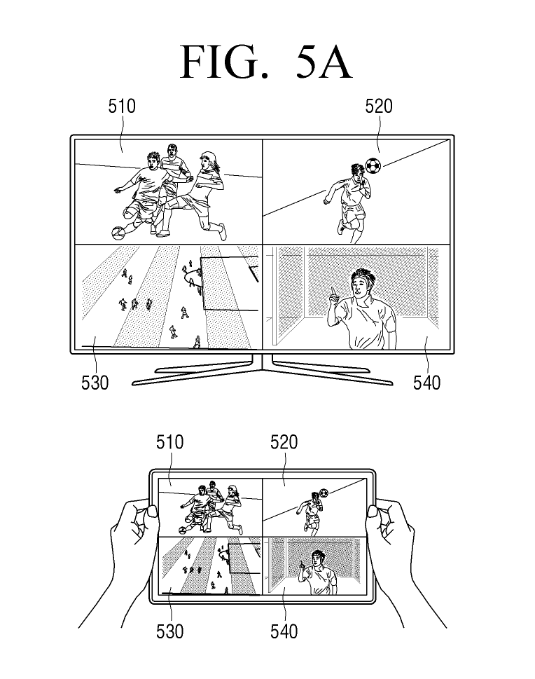

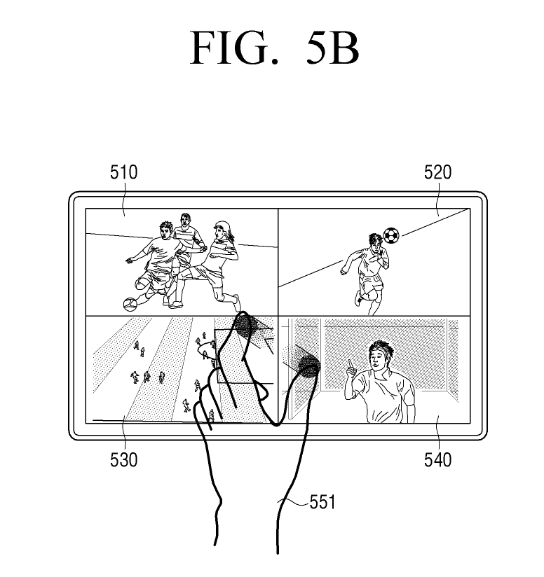

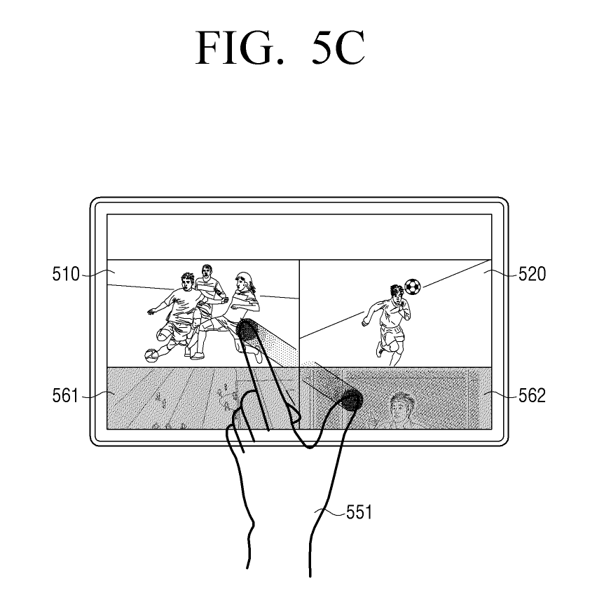

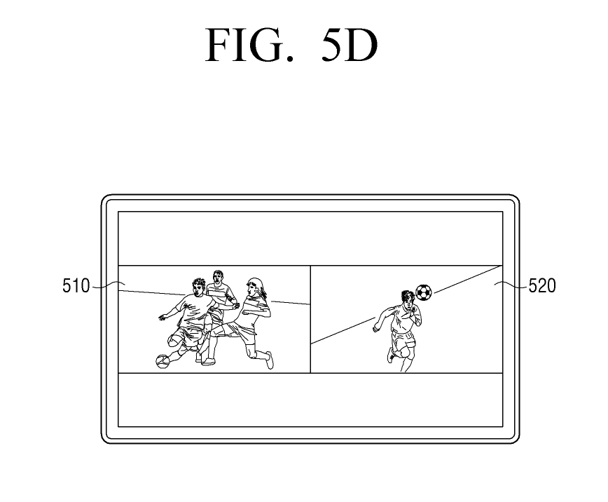

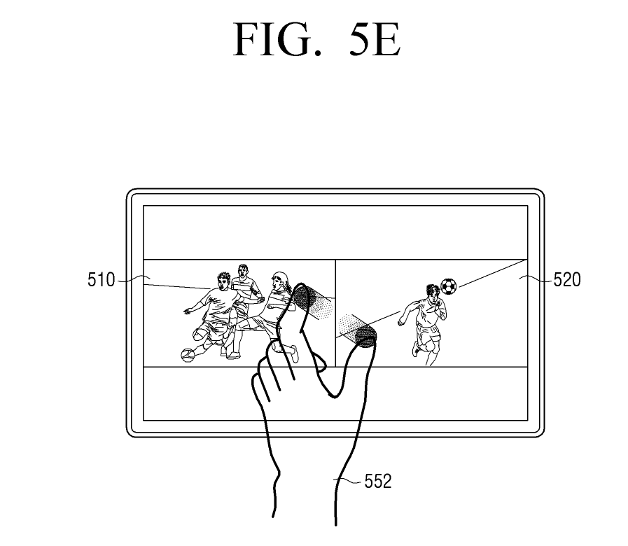

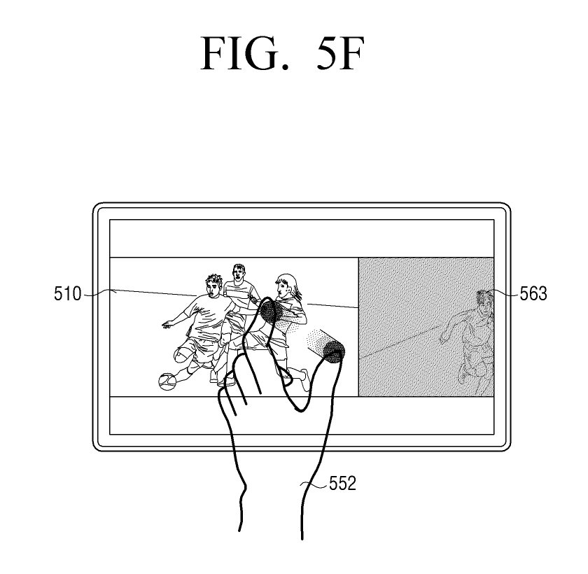

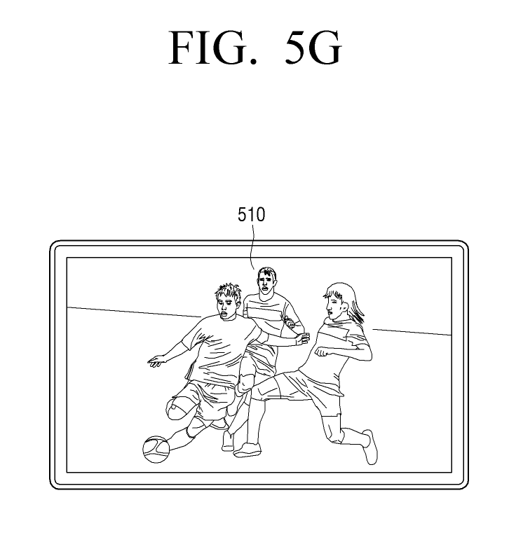

FIGS. 5A to 5G are views illustrating a method of changing the number of image contents displayed on the user terminal device 100 according to another exemplary embodiment.

Referring to FIG. 5A, the display apparatus 200 may display first to fourth image contents 510-540 in quadrants, and the controller 140 may control the first to the fourth image contents 510-540 to be displayed in quadrants on the display 110. In this case, the display apparatus 200 may receive the first to the fourth image contents 510-540 from the display apparatus 200 or an external server. The first to the fourth image contents 510-540, for example, may be broadcast contents of different channels, which are provided by different broadcast stations. Alternatively, the first to the fourth image contents 510-540 may be the same broadcast content watched from different camera angles. Further, one of the first to the fourth image contents 510-540 may be an image content including information related to a broadcast content (for example, program information, broadcast station, performer information, etc.).

Referring to FIG. 5B, while the first to the fourth image contents 510-540 are displayed on the display 110, the detector 130 may detect a pinch open interaction 551 of touching the display 110 with two fingers and widening the distance between the two fingers.

Referring to FIG. 5C, if the distance between the two fingers of the pinch open interaction 551 is within a predetermined distance, the controller 140 may control display of parts of the third image content 530 and the fourth image content 540 on each of external areas 561, 562 of the first image content 510 and the second image content 520, respectively. In this case, the parts of the third image content 530 and the fourth image content 540 may be displayed with a dimming effect. Alternatively, the controller 140 may control display of detailed information regarding the first image content 510 and the second image content on each of the external areas 561, 562. In this case, the detailed information may be, for example, at least one of title, broadcast time, characters, story, review, etc. Further, the controller 140 may control display of broadcast timetable, advertisement information, etc. on the external areas 561, 562.

If the distance between the two fingers of the pinch open interaction 551 is within a predetermined distance, displaying information on the external areas 561, 562 may provide a visual effect to guide a user to widen the distance between the two fingers of the pinch open interaction 551. The detector 130 may continue to detect the pinch open interaction 551 further widening the distance between the two fingers apart from each other by a predetermined distance.

Referring to FIG. 5D, in response to the pinch open interaction 551, the controller 140 may control to display the first image content 510 and the second image content 520. In this case, the third image content 530 and the fourth image content 540 may be removed from the display 110.

Referring to FIG. 5E, while the first image content 520 and the second image content 520 are displayed on the display 110, the detector 130 may detect a pinch open interaction 552 of touching the display 110 with two fingers and widening the distance between the two fingers.

Referring to FIG. 5F, if the distance between the two fingers of the pinch open interaction 552 is within a predetermined distance, the controller 140 may control display of a part of the second image content 520 having a dimming effect applied in an external area 563 of the first image content 510. Alternatively, the controller 140 may control to display detailed information regarding the first image content 510 or broadcast timetable, advertisement information, etc. on the external area 563. The detector 130 may continue to detect the pinch open interaction 552 of further widening the distance between the two fingers apart from each other by a predetermined distance.

Referring to FIG. 5G, in response to the pinch open interaction 552, the controller 140 may control enlargement of the first image content 510. In this case, the second image content 520 may be removed.

FIGS. 5A to 5G illustrate an exemplary embodiment in which the number of image contents is reduced in response to a pinch open interaction, but the number of image contents may increase in response to a pinch close interaction according to another exemplary embodiment. On the other hand, the number of image contents may increase in response to a pinch open interaction, and the number of image contents may decrease in response to a pinch close interaction.

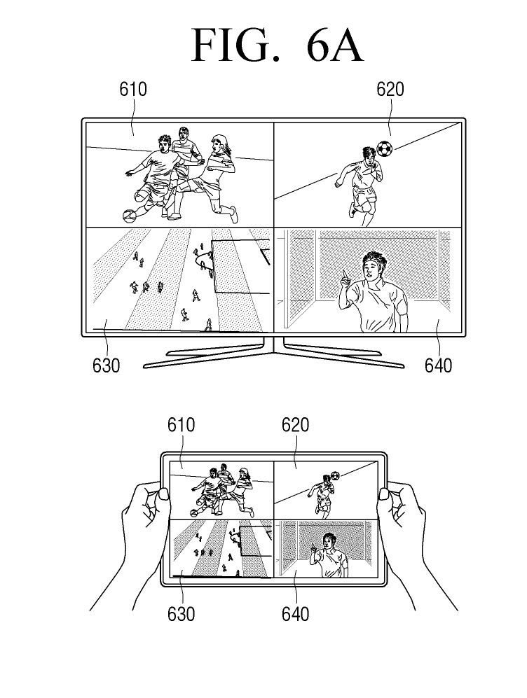

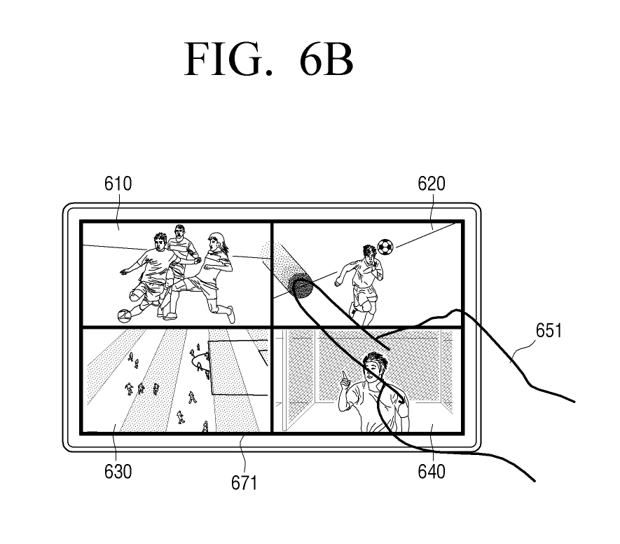

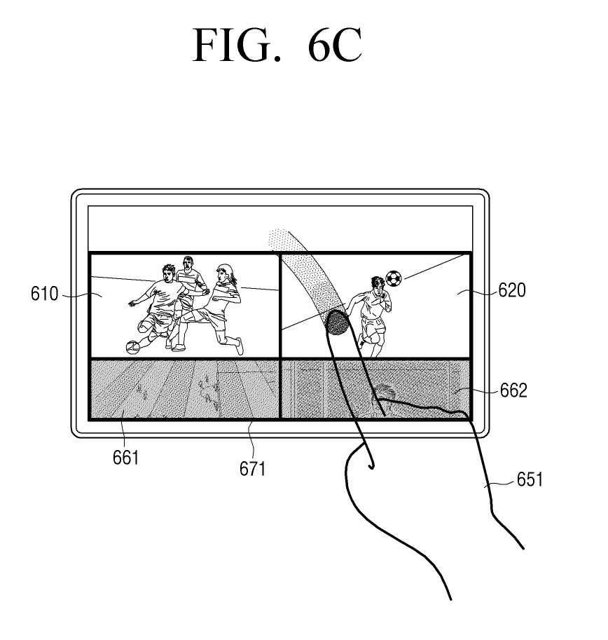

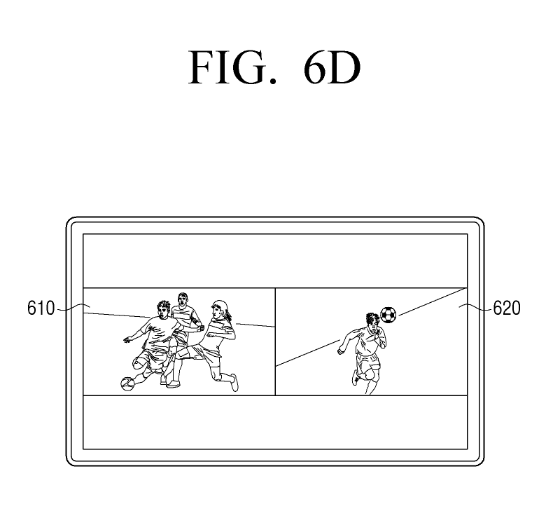

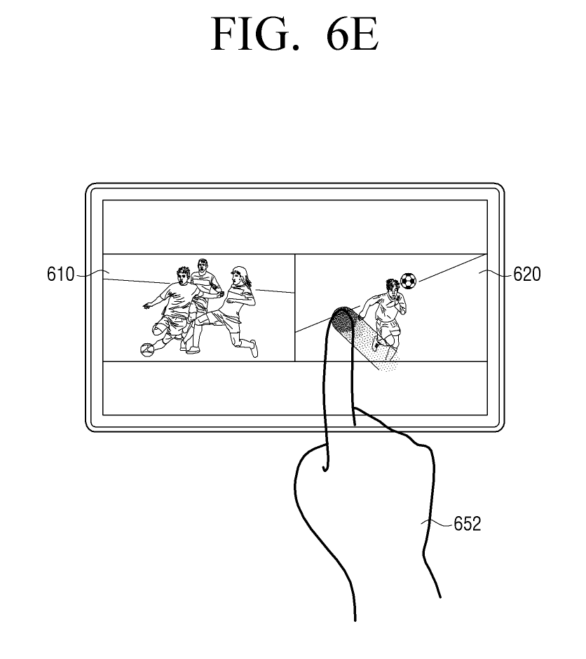

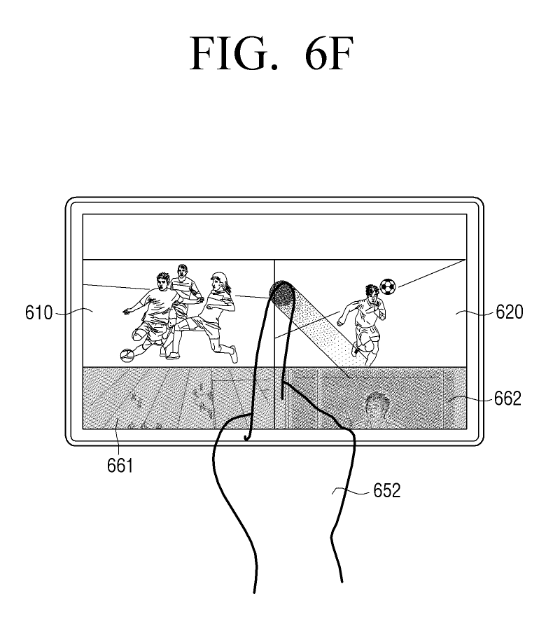

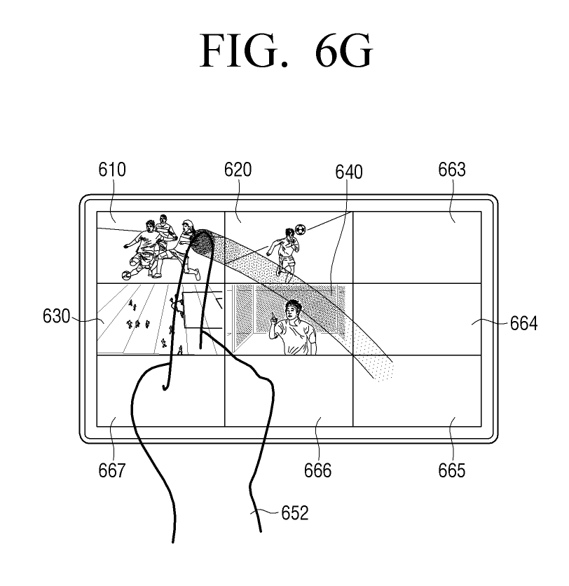

FIGS. 6A to 6G are views illustrating a method of changing the number of image contents displayed on the user terminal device 100 according an exemplary embodiment.

Referring to FIG. 6A, the display apparatus 200 may display first to fourth image contents 610-640, and the controller 140 may control display of the first to the fourth image contents 610-640 on the display 110. In this case, the controller 140 may receive the first to the fourth image contents 610-640 from an external server.

Referring to FIG. 6B, while the first to the fourth image contents 610-640 are displayed on the display 110, the detector 130 may detect a touch drag interaction 651 of touching an edge of the first image content 610 and dragging the touched edge in a lower or right direction. In this case, when the touch of the touch drag interaction 651 is performed, the controller 140 may control display of a visual effect 671 to inform a user that the number of image contents is changeable. The visual effect 671 may be provided, for example, by changing, highlighting, or flickering the color of the edge of the first to the fourth image contents 610-640.

Referring to FIG. 6C, if the dragging direction of the touch drag interaction 651 is within a predetermined distance, the controller 140 may control to display parts of the third image content 630 and the fourth image content 640 having a dimming effect applied on each of external areas 661,662 of the first image content 610 and the second image content 620. Alternatively, the controller 140 may control to display detailed information of the first image content 610 and the second image content 620, or broadcast timetable, advertisement information, etc. on each of the external areas 661,662.

If the dragging direction of the touch drag interaction 651 is within a predetermined distance, displaying information on the external areas 661,662 may provide a visual effect to guide a user to extend the dragging distance of the touch drag interaction 651. The detector 130 may continue to detect the touch drag interaction 651 of extending the dragging distance to be longer than a predetermined distance.

Referring to FIG. 6D, in response to the touch drag interaction 651, the controller 140 may control display of the first image content 610 and the second image content 620. In this case, the third image content 630 and the fourth image content 640 may be removed.

Referring to FIG. 6E, while the first image content 610 and the second image content 620 are displayed on the display 110, the detector 130 may detect a touch drag interaction 652 of touching an edge of the second image content 620 and dragging the touched edge in a upper or left direction.

Referring to FIG. 6F, if the dragging distance of the touch drag interaction 652 is within a predetermined distance, the controller 140 may control to display parts of the third image content 630 and the fourth image content 640 having a dimming effect applied on each of the external areas 661, 662 of the first image content 610 and the second image content 620. Alternatively, the controller 140 may control to display detailed information of the first image content 610 and the second image content 620, or broadcast timetable, advertisement information, etc. on each of the external areas 661, 662.

Referring to FIG. 6G, if the touch drag interaction 652 continues, the controller 140 may control display of the first to the fourth image contents 610-640 on the display 110. The controller 140 may control to display detailed information of the first to the fourth image contents 610-640 or broadcast timetable, advertisement information, etc. on external areas 663-667 of the first to the fourth image contents 610-640.

In FIGS. 6A to 6G, the number of image contents may decrease in response to a touch drag interaction in a lower or right direction, and the number of image contents may increase in response to a touch drag interaction in an upper or left direction. However, according to another exemplary embodiment, the number of image contents may increase in response to a touch drag interaction in a lower or right direction, and the number of image contents may decrease in response to a touch drag interaction in an upper or left direction.

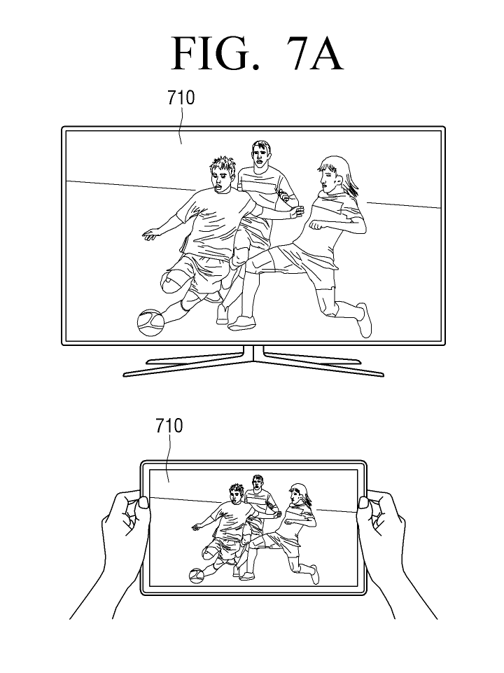

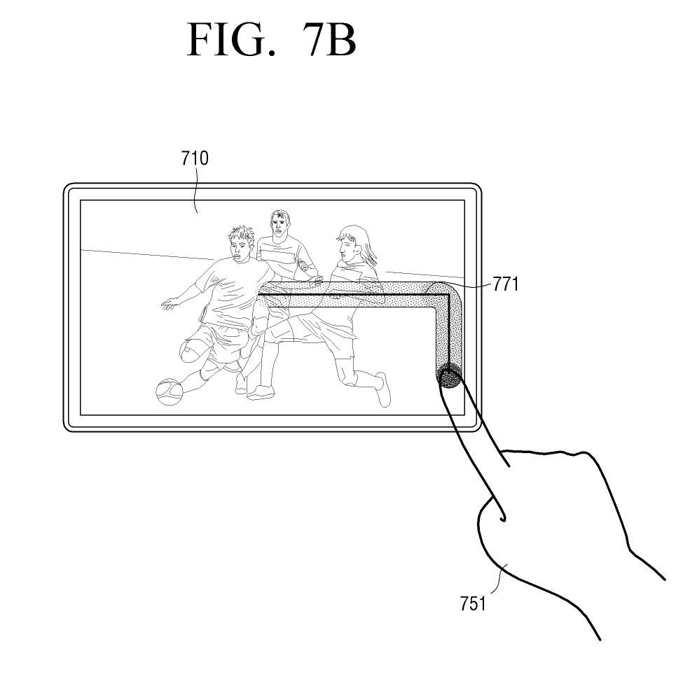

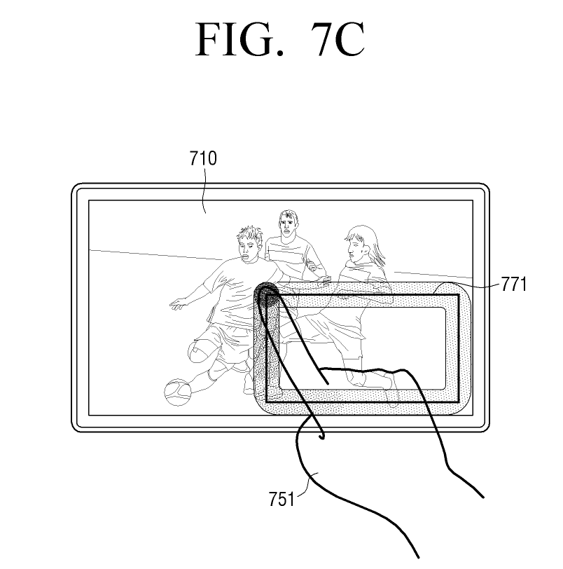

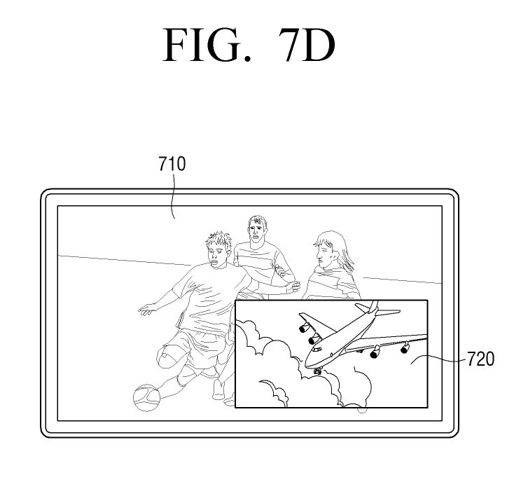

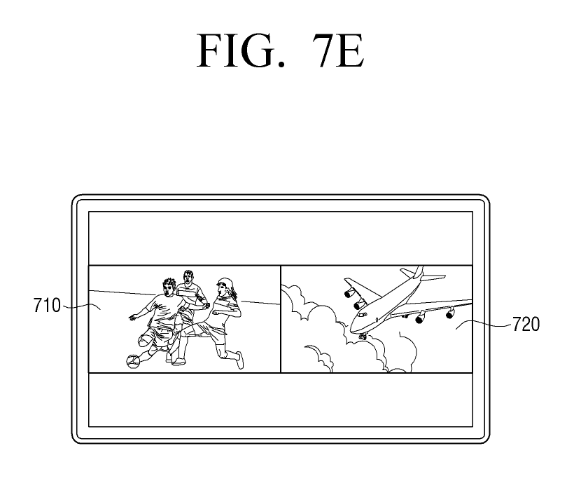

FIGS. 7A to 7E are views illustrating a method of changing the number of image contents displayed on the user terminal device 100 according to an exemplary embodiment.

Referring to FIG. 7A, the display apparatus 200 may display a first image content 710, and the controller 140 may control display of the first image content 710 on the display 110. In this case, the controller 140 may receive the first image content 710 from the display apparatus 200 or an external server.

Referring to FIG. 7B, while the first image content 710 is displayed on the display 110, the detector 130 may detect a touch drag interaction 751 corresponding to a shape (for example, a square, triangle, rectangle, etc.) within the first image content 710. In this case, the controller 140 may control display of a visual effect 771 at the location of the touch drag interaction 751 so that a user may recognize the process of drawing the closed curve. The visual effect 771 may include, for example, changing, highlighting, or flickering the color corresponding to the input.

Referring to FIG. 7C, the detector 130 may continue to detect the touch drag interaction 751. If a closed shape is completed by the touch drag interaction 751, the controller 140 may control to display a visual effect indicating that the closed shape is completed. The visual effect nay include, for example, changing, highlight, or flickering the closed shape or the color of the area within the shape curve. Meanwhile, the start point and the end point of the closed shape are not necessarily connected by the touch drag interaction 751, and if a side is formed inside a trace when a straight line is drawn between an initial touch point and a touch release point, it is determined that a closed shape is drawn. The closed shape may be a square, a circle, or other arbitrary shapes, and the controller 140 may automatically adjust the shape to form a circle or a polygon even if a trace of the shape is irregular.

Referring to FIG. 7D, in response to the touch drag interaction 751, the controller 140 may control to display a second image content 720 within a display area corresponding to the shape. In other words, the controller 140 may control to display the second image content 720 within the first image content 710 in the form of Picture In Picture (PIP).

FIG. 7E illustrates another exemplary embodiment in which the controller 140 controls display of the first image content 710 and the second image content 720 in response to the touch drag interaction 751. Referring to FIG. 7E, in response to the touch drag interaction 751, the controller 140 may control display of the second image content 720 outside the first image content 710. In this case, the size of the first image content 710 and the size of the second image content 720 may be determined according to the size of a closed shape. For example, the controller 140 may control display of the second image content 720 inside a closed shape, and display the first image content 710 outside the second image content 720 in a size the same as or similar to the size of the closed shape. In other words, the controller 140 may control display of the second image content 720 outside the first image content 710 in the form of Picture Out Picture (POP).

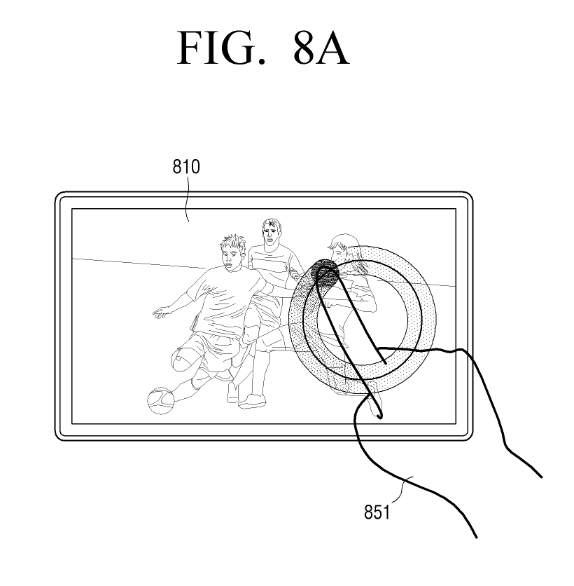

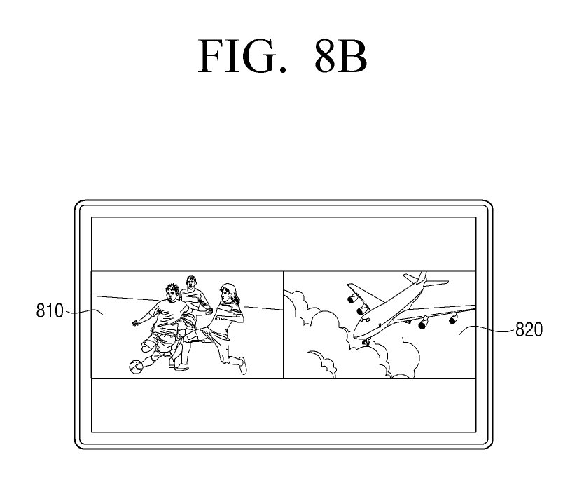

FIGS. 8A to 8B are views illustrating a method of changing the number of image contents displayed on the user terminal device 100 according to an exemplary embodiment.

Referring to FIG. 8A, while a first image content 810 is displayed on the display 110, the detector 130 may detect a touch drag interaction 851 to draw a closed shape (for example, a circle) within the first image content 810.

Referring to FIG. 8B, in response to the touch drag interaction 851, the controller 140 may control display of the first image content 810 and a second image content 820. The controller 140 may control display of the second image content 820 with reference to a center of a closed shape along with the first image content 810. For example, if a closed shape is a circle, the center of the closed shape may be a center of the circle, and if a closed shape is a polygon, the center of the closed shape may be a center of gravity of the polygon. The controller 140 may control display of the second image content 820 such that a center of a closed shape becomes a center of an area at which the second image content 820 is displayed. In this case, the size of the second image content 820 may be predetermined. Alternatively, the size of the second image content 820 may be determined according to a size of a closed curve. For example, if a closed shape is a circle, the length of the second image content 820 may be the same as the diameter of the circle. Accordingly, as the diameter of the circle increases, the size of the second image content 820 may correspondingly increase.

If the size or location of the second image content 820 is determined, the controller 140 may control display of the second image content 820 outside the first image content 810. In other words, the controller 140 may control display of the second image content 820 outside the first image content 810 in the form of POP.

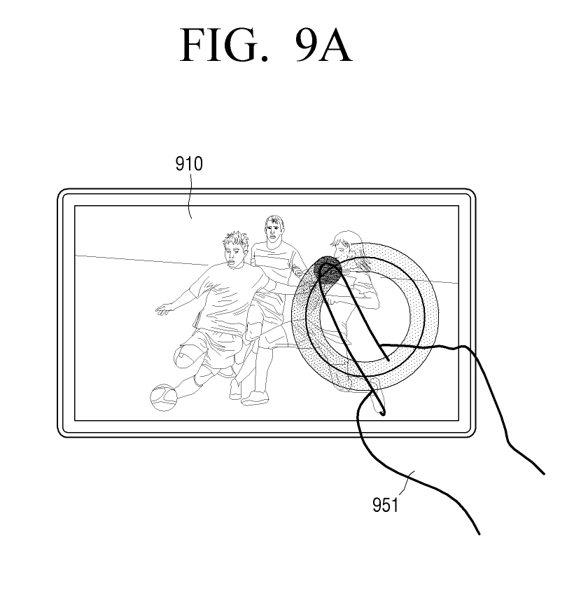

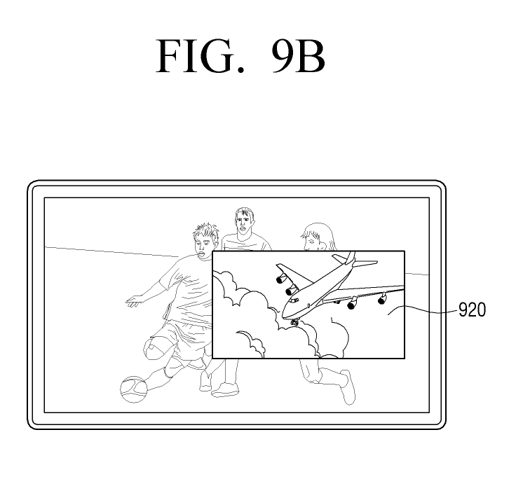

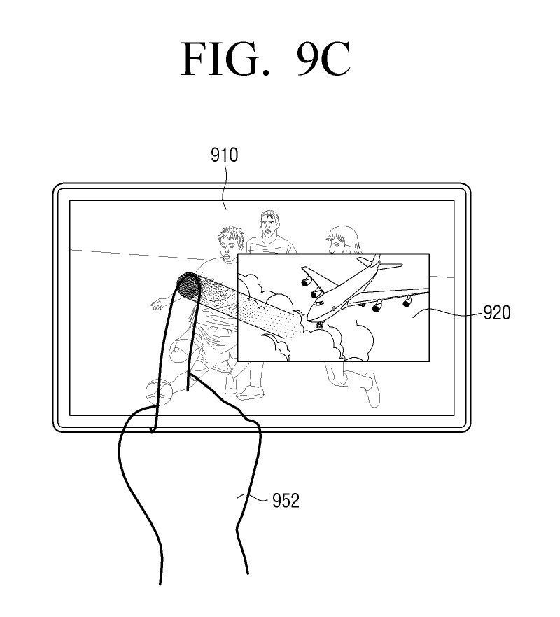

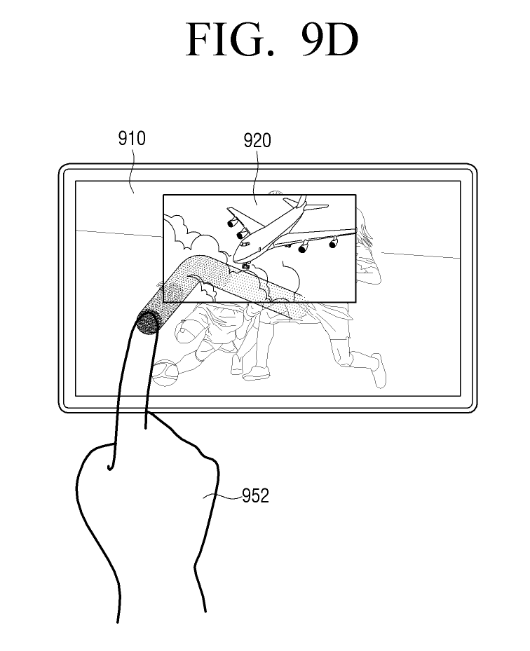

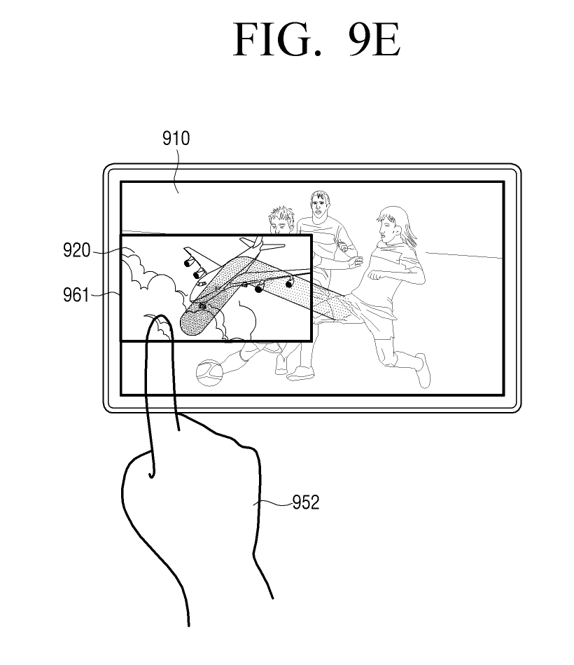

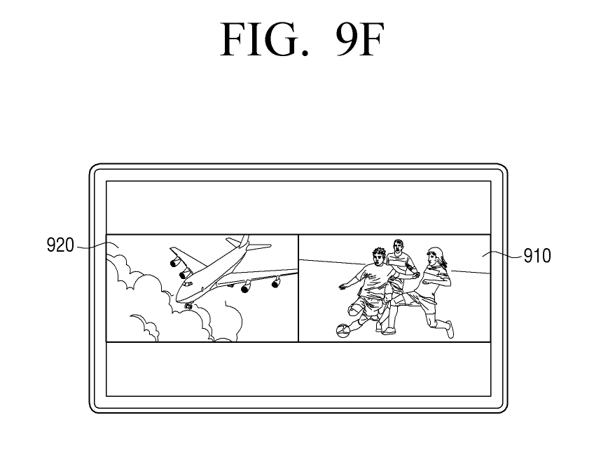

FIGS. 9A to 9F are views illustrating a method of changing the number of image contents displayed on the user terminal device 100 according to an exemplary embodiment.

Referring to FIG. 9A, while a first image content 910 is displayed on the display 110, the detector 130 may detect a touch drag interaction 951 to draw a closed shape (for example, a circle) within the first image content 910.

Referring to FIG. 9B, in response to the touch drag interaction 951, the controller 140 may control display of the first image content 910 and a second image content 920. In this case, the size or location of the second image content may be determined as described above with reference to FIG. 8B. If the size or location of the second image content 920 is determined, the controller 140 may control display of the second image content 920 within the first image content 910. In other words, the controller 140 may control display of the second image content 920 within the first image content 910 in the form of PIP.

Referring to FIG. 9C, while the first image content 910 and the second image content 920 are displayed on the display 110, the detector 130 may detect a touch drag interaction 952 of touching within the second image content 920 and dragging the second image content 920 to a different location to move the second image content 920.

Referring to FIG. 9D, in response to the touch drag interaction 952, the controller 140 may control display of the first image content 910 and the second image content 920 in the different location on the display 110. The detector 130 may continue to detect the touch drag interaction 952 of moving the second image content 920 to subsequently reposition the second image content 920 to additional different locations when receiving input within the second image content 920.

Referring to FIG. 9E, in response to the touch drag interaction 952, the controller 140 may control display of the first image content 910 and the second image content 920. In this case, if an edge 961 of the second image content 920 contacts one side of the display 110, the controller 140 may provide an effect of changing, highlighting, or flickering the color of the edge of the first image content 910. In this case, the detector 130 may detect the touch drag interaction of releasing the touch on the second image content 920.

Referring to FIG. 9F, in response to the touch drag interaction 952 of releasing the touch, the controller 140 may control display of the second image content 920 outside the first image content 910. In other words, the controller 140 may control display of the second image content 920 outside the first image content 910 in the form of POP.

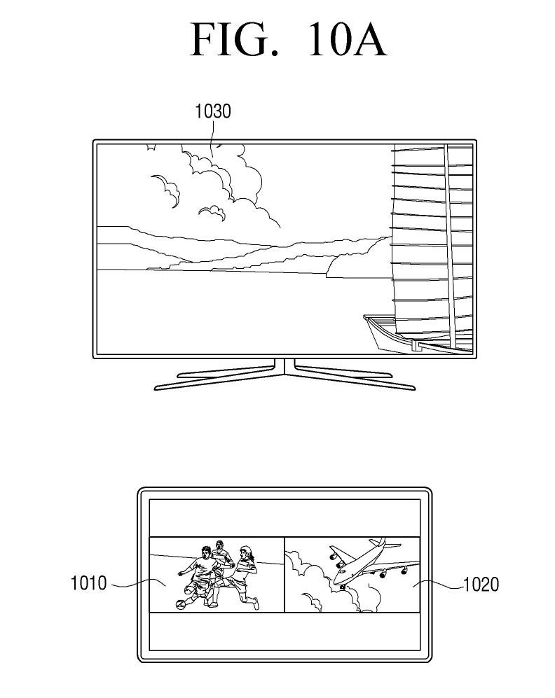

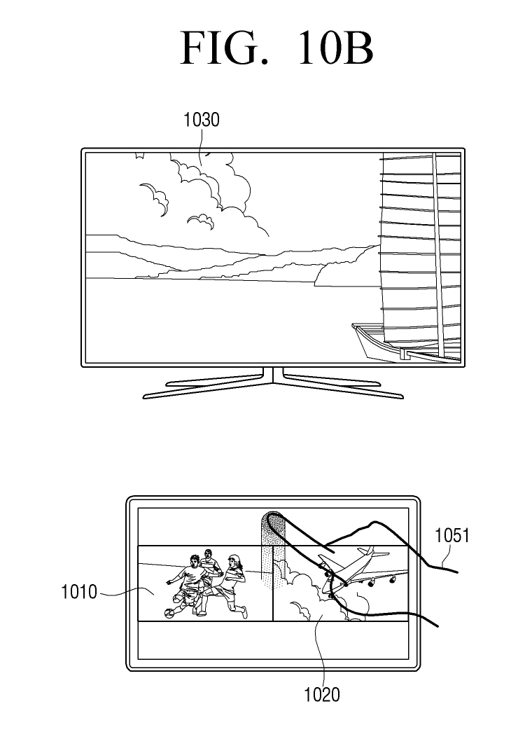

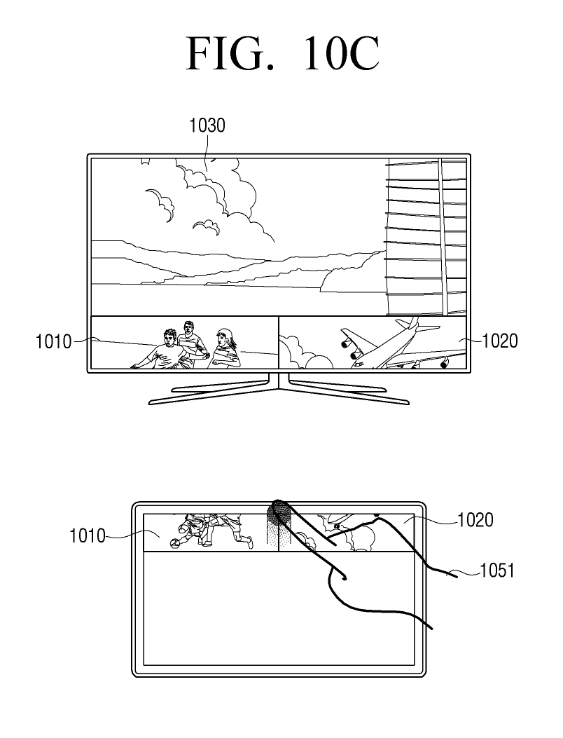

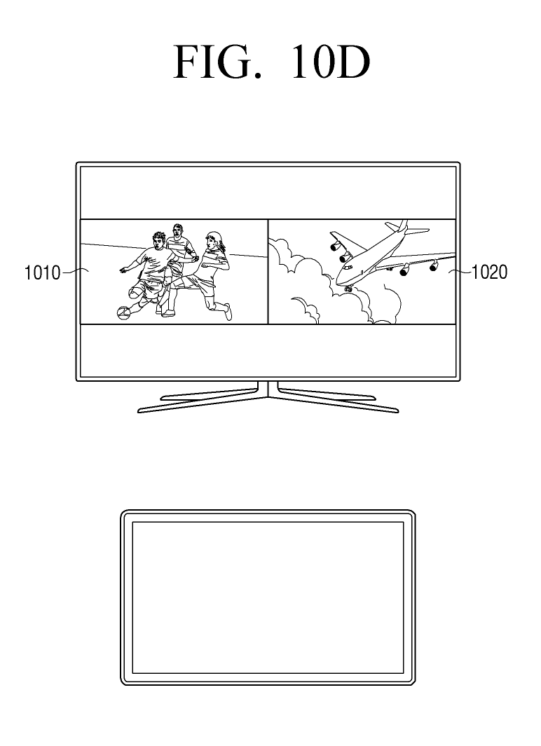

FIGS. 10A to 10D are views illustrating a method of displaying an image content displayed on the user terminal device 100 on the display apparatus 200 according to an exemplary embodiment.

Referring to FIG. 10A, the display apparatus 200 may display a third image content 1030. As the result of the number of the image contents being changed, the controller 140 may control display of a first image content 1020 and a second image content 1010 on the display 110.

Referring to FIG. 10B, while the first image content 1010 and the second image content 1020 are displayed on the display 110, the detector 130 may detect a touch drag interaction 1051 of touching on a location of a border line between the first image content 1010 and the second image content 1020 and dragging the touched border line in an upper direction.

Referring to FIG. 10C, as the touch drag interaction 1051 proceeds in an upwards direction, the controller 140 may control the first image content 1010 and the second image content 1020 to move upwards. In this case, the controller 140 may transmit information regarding the first image content 1010 and the second image content 1020 so that the first image content 1010 and the second image content 1020 are displayed on the external display apparatus 200. For example, the controller 140 may transmit information regarding the first image content 1010 and the second image content 1020 to an external display apparatus or an external server that provides the first image content 1010 and the second image content 1020. In addition, the controller 140 may also provide information regarding the first image content 1010 and part of the second image content 1020 displayed on the display 110. The external display apparatus may display the first image content 1010 and another part of the second image content 1020. In this case, the first image content 1010 and another part of the second image content 1020 may be the first image content 1010 and another part of the second image content 1020 that disappear from the display 110 according to the touch drag interaction 1051. The detector 130 may detect the touch drag interaction 1051 of touching a border line between the first image content 1010 and the second image content 1020 and continuously dragging the touched border line in an upwards direction.

Referring to FIG. 10D, in response to the touch drag interaction 1051, the controller 140 may remove the first image content 1010 and the second image content 1020 from the display 110. In response to the touch drag interaction 1051, the external display apparatus 200 may display the first image content 1010 and the second image content 1020.

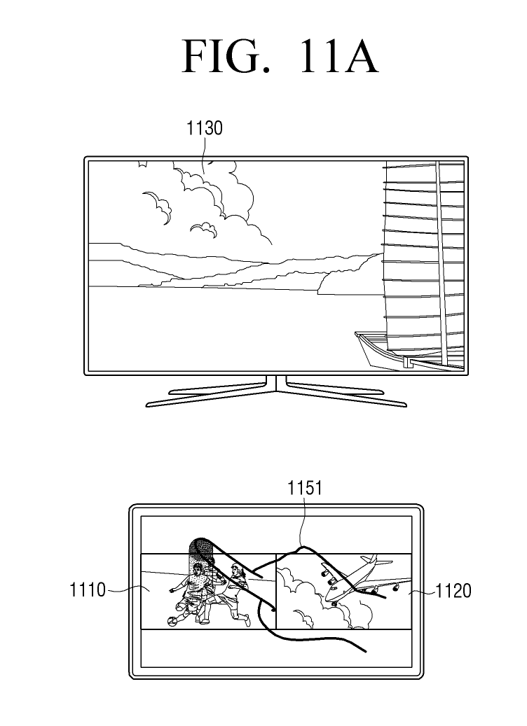

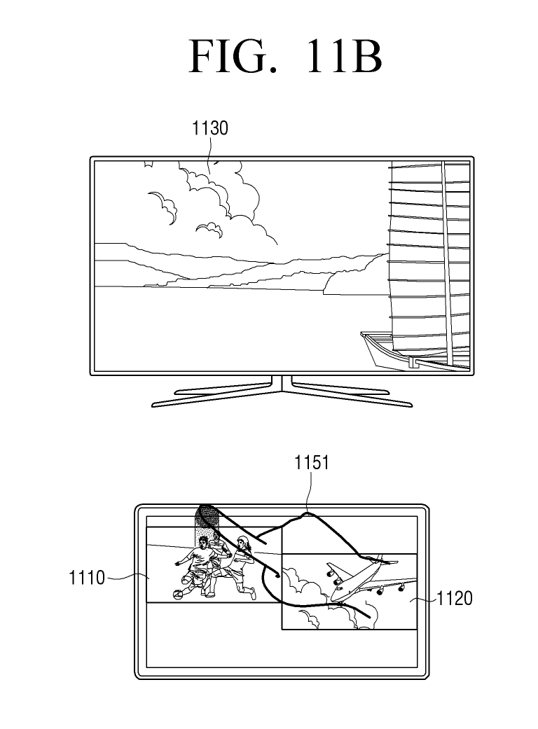

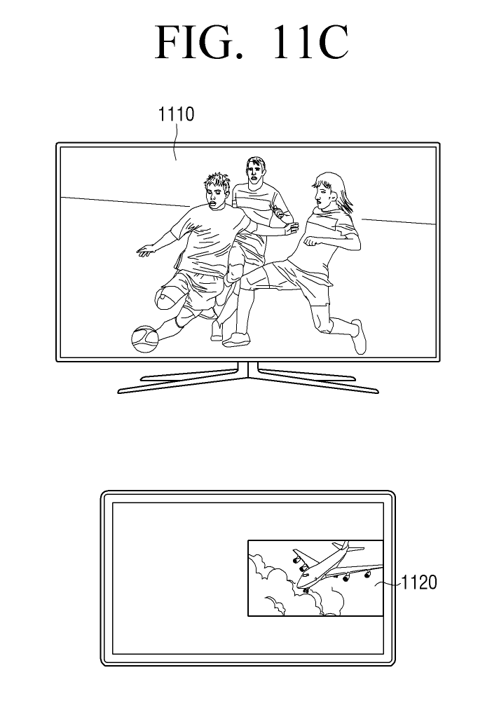

FIGS. 11A to 11C are views illustrating a method of displaying an image content displayed on the user terminal device 100 on the display apparatus 200 according to another exemplary embodiment.

Referring to FIG. 11A, while a first image content 1110 and a second image content 1120 are displayed on the display 110, the detector 130 may detect a touch drag interaction 1151 of touching the first image content 1110 and dragging the touched first image content 1110 in an upwards direction.

Referring to FIG. 11B, as the touch drag interaction 1151 proceeds in an upwards direction, the controller 140 may control the first image content 1110 to correspondingly move upwards.

The controller 140 may control transmission of information regarding the first image content 1110 so that the first image content 1110 is displayed on the external display apparatus 200. In this case, the controller 140 may control transmission of information regarding the first image content 110 to the external display apparatus 200 or an external server that provides the first image content 1110.

Referring to FIG. 11C, in response to the touch drag interaction 1151, the controller 140 may control removal of the first image content 1110 from the display 110 and display of the second image content 1120. On the other hand, in response to the touch drag interaction 1151, the external display apparatus 200 may display the first image content 1110.

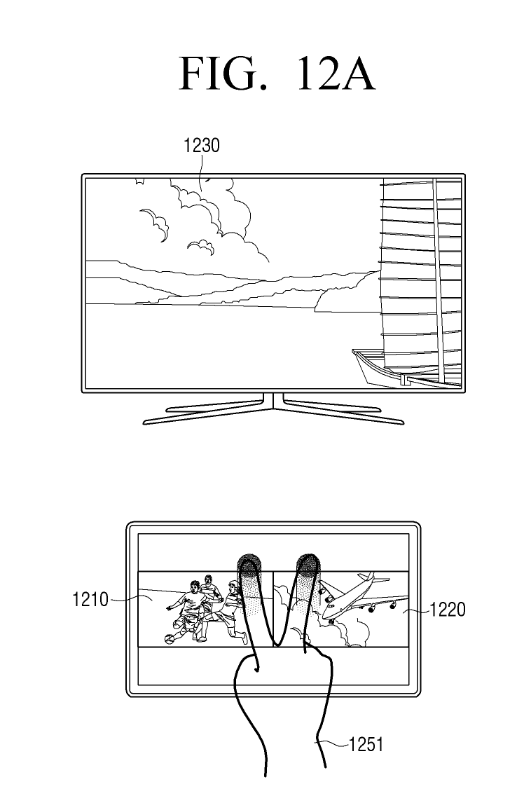

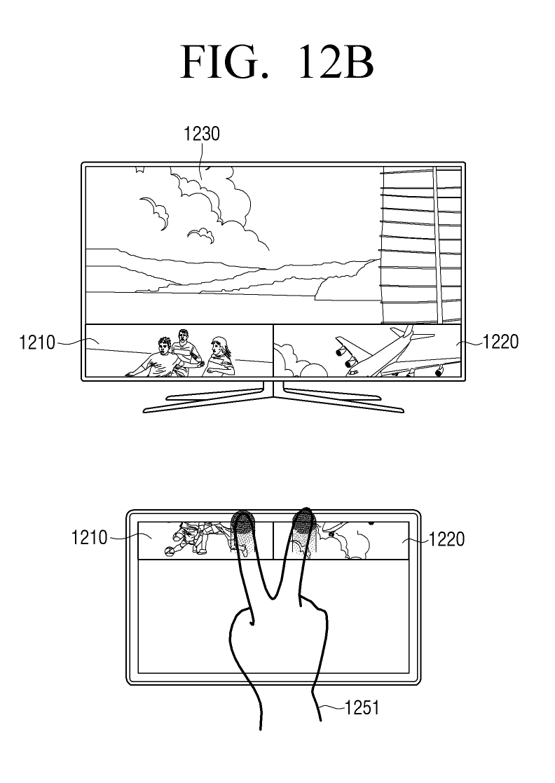

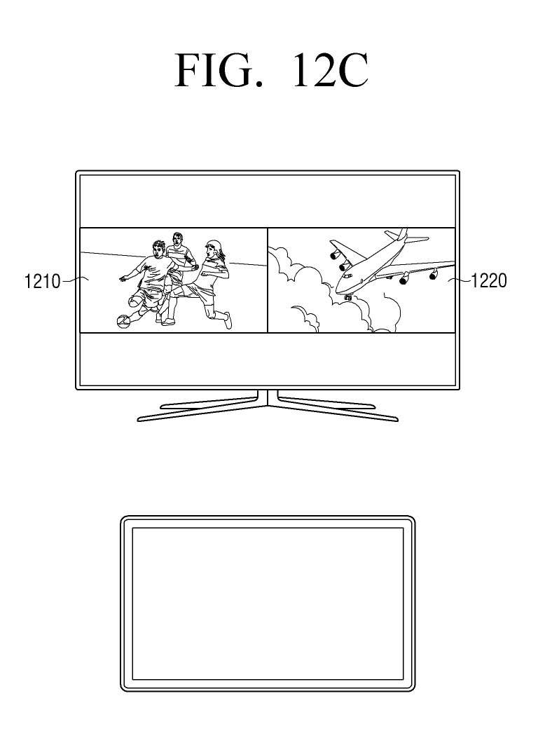

FIGS. 12A to 12C are views illustrating a method of displaying an image content displayed on the user terminal device 100 on the display apparatus 200 according to another exemplary embodiment.

Referring to FIG. 12A, while a first image content 1210 and a second image content 1220 are displayed on the display 110, the detector 130 may detect a multi touch drag interaction 1251 of touching the first image content 1210 and a second image content 1220 with two fingers (simultaneously or almost simultaneously) and dragging the touched image contents in an upwards direction.

Referring to FIG. 12B, as the dragging of the multi touch drag interaction 1251 proceeds in one direction, the controller 140 may control the first image content 1210 and the second image content 1220 in the corresponding direction. The controller 140 may control transmission of information regarding the first image content 1210 and the second image content 1220 so that the first image content 1210 and the second image content 1220 are displayed on the external display apparatus 200. In addition, the controller 140 may also control transmission of information regarding the first image content 1210 displayed on the first display 110 and part of the second image content 1220. The external display apparatus 200 may display the first image content 1210 and another part of the second image content 1220. In this case, the first image content 1210 and the another part of the second image content 1220 may be the first image content 1210 and the another part of the second image content 1220 that disappear from the display 110 according to the dragging of the touch drag interaction 1251 on the display 110. The detector 130 may detect the multi touch drag interaction 1251 of touching a position of a border line between the first image content 1210 and the second image content 1220 and continuously dragging the touched border line in an upwards direction.

Referring to FIG. 12C, in response to the multi touch drag interaction 1251, the controller 140 may control removal of the first image content 1210 and the second image content 1220 from the display 110. On the other hand, in response to the multi touch drag interaction 1251, the external display apparatus 200 may display the first image content 1210 and the second image content 1220.

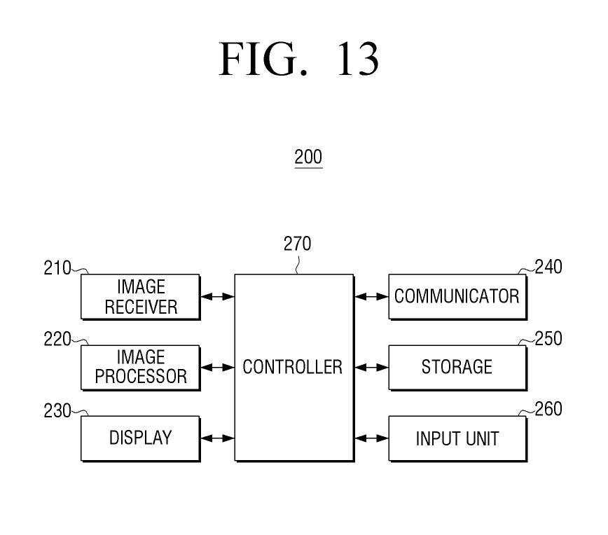

Hereinafter, the display apparatus 200 will be described in detail with reference to FIG. 13.

As illustrated in FIG. 13, the display apparatus 200 includes an image receiver 210, an image processor 220, a display 230, a communicator 240, a storage 250, an input unit 260, and a controller 270.

The image receiver 210 receives an image stream from a source. In particular, the image receiver 210 may receive an image stream including a broadcast content from an external broadcast station and an image stream including a VOD image content from an external server.

The image receiver 210 may include a plurality of tuners to display a plurality of broadcast contents or transmit a plurality of broadcast contents to the external user terminal 100. In this case, the image receiver 210 may include two tuners, but this is only an example. The image receiver 210 may include more than two tuners.

The image processor 220 may process an image stream received through the image receiver 210. Specifically, the image processor 220 may process image streams such that only one image content is displayed in a single mode and two image contents are displayed in a dual mode. In particular, if information regarding an image content is received from the user terminal device 100, the image processor 220 may process the image content according to the length of the dragging of a drag interaction.

The display 230 displays at least one image content under the control of the controller 270. In particular, the display 230 may display only one image content in a single mode, and display a plurality of image contents in a dual mode.

The communicator 240 communicates with various external apparatuses. In particular, the communicator 240 may communicate with the external display apparatus 100. Specifically, the communicator 240 may transmit an image content to the user terminal device 100, and receive information regarding an image content including a control command from the user terminal device 100.

The storage 250 may be memory that stores various data and programs to drive the display apparatus 200. In particular, the storage 250 may include a buffer that temporarily stores an image content so that an image content is displayed through synchronization with the user terminal device 100. The buffer may output an image content to the image processor 220 or the display 230 using timestamp information included in the image stream.

The input unit 260 receives various user commands to control the display apparatus 200. In this case, the input unit 260 may be realized as a remote controller, but this is only an example. The input unit 260 may be realized as various user interface input apparatuses, such as pointing device, motion input device, voice input device, mouse, keyboard, etc.

The controller 270 may be a processor that controls overall operations of the display apparatus 200. Specifically, the controller 270 may control the communicator 240 to transmit a first image content to the user terminal device 100. The controller 270 may control the image processor 220 to generate an image stream by multiplexing the first image content and a second image content. The controller 270 may control the communicator 240 to transmit the multiplexed image stream to the user terminal device 100.

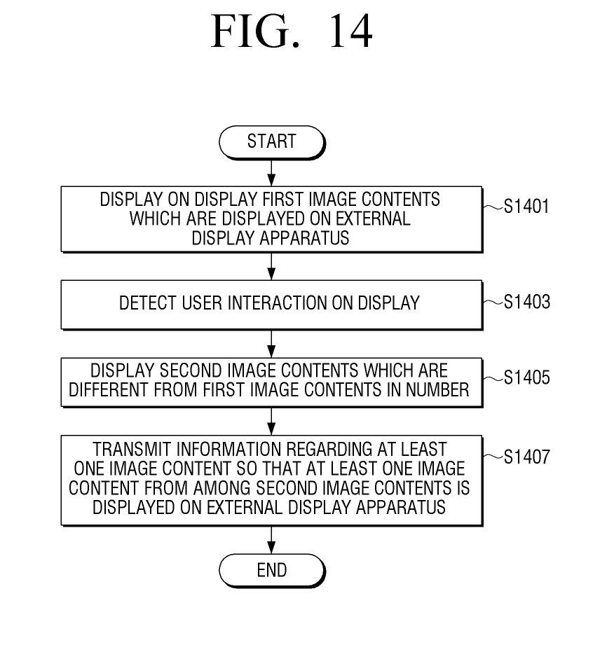

FIG. 14 is a flowchart illustrating a method through which the user terminal device 100 controls the display apparatus 200 according to an exemplary embodiment.

Referring to FIG. 14, the user terminal device 100 may display multiple image contents displayed on the display apparatus 200 (S1401). The multiple image contents may be, for example, broadcast contents. The user terminal device 100 may detect a user interaction on the display 110 (S1403). The user terminal device 100 may display other image contents different from the multiple image contents on the display 110 and the display apparatus 200 in response to a user interaction (S1405). In this case, the other image contents may include the multiple image contents that are reduced and at least one image content different from the multiple image contents. Subsequently, the user terminal device 100 may transmit information regarding at least one image content displayed thereon so that at least one image content from among the image contents displayed on the display 110 of the user terminal device 100 is displayed on the display apparatus 200 (S1407). For example, the user terminal device 100 may transmit information regarding at least one image content to the display apparatus 200 or a server that provides an image content. If a server that provides an image content receives information regarding at least one image content, the server may provide at least one image content to the display apparatus 200.

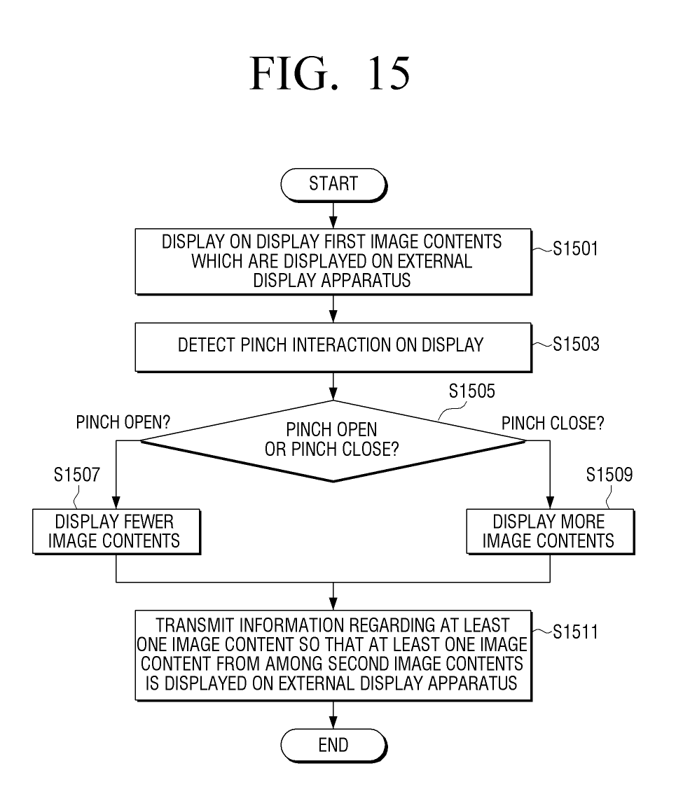

FIG. 15 is a flowchart illustrating a method through which the user terminal device 100 controls the display apparatus 200 according to another exemplary embodiment.

Referring to FIG. 15, the user terminal device 100 may display multiple image contents displayed on the display apparatus 200 (S1501). The user terminal device 100 may detect a pinch interaction on the display 110 (S1503). The user terminal device 100 may determine whether the detected pinch interaction is a pinch open interaction of widening the distance between fingers or a pinch close interaction of narrowing the distance between fingers (S1505). If the detected pinch interaction is a pinch open interaction, the user terminal device may display other image contents fewer than the multiple image contents (S1507). On the other hand, if the detected pinch interaction is a pinch close interaction, the user terminal device 100 may display an increased number of image contents greater than the multiple image contents (S1509). Subsequently, the user terminal device 100 may transmit information regarding at least one image content so that at least one image content from among image contents displayed on the display 110 of the user terminal device 100 is displayed on the display apparatus 200 (S1511). For example, in response to a user interaction of selecting at least one image content, the user terminal device 100 may transmit information regarding at least one image content to the display apparatus 200.

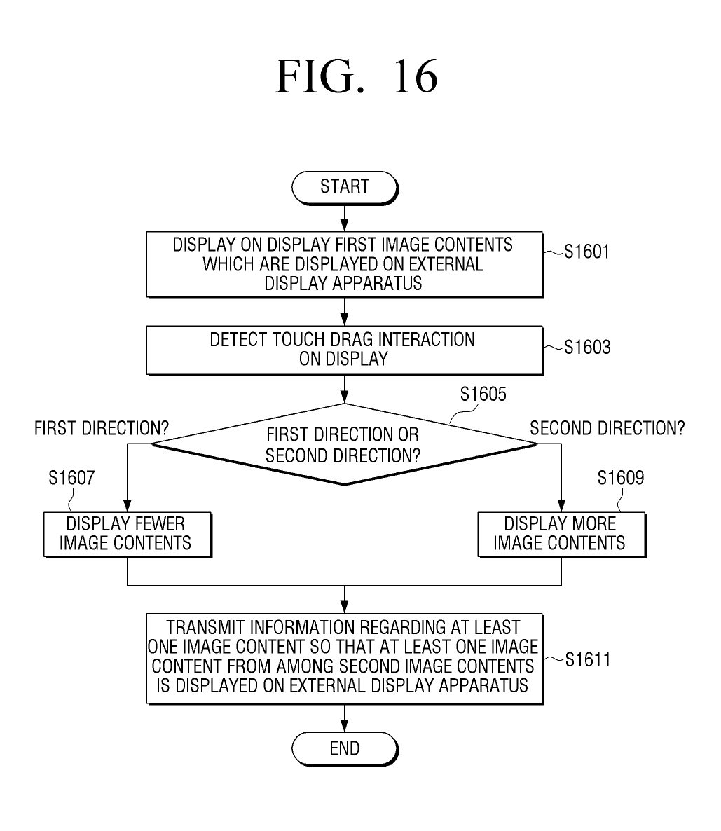

FIG. 16 is a flowchart illustrating a method through which the user terminal device 100 controls the display apparatus 200 according to another exemplary embodiment.

Referring to FIG. 16, the user terminal device 100 may display multiple image contents displayed on the display apparatus 200 (S1601). The user terminal device 100 may detect a touch drag interaction on the display 110 (S1603). The user terminal device 100 may determine whether the detected touch drag interaction moves in a first direction or in a second direction (S1605). If the detected touch drag interaction moves in the first direction, the user terminal device 100 may display fewer image contents less than the multiple image contents (S1607). On the other hand, if the detected touch drag interaction moves in the second direction, the user terminal device may display more image contents greater than the multiple image contents (S1609). For example, the first direction may be a lower direction or a right direction, and the second direction may be an upper direction or a left direction. Subsequently, the user terminal device 100 may transmit information regarding at least one image content so that at least one image content from among the image contents displayed on the display 110 of the user terminal device 100 is displayed on the display apparatus 200 (S1611).

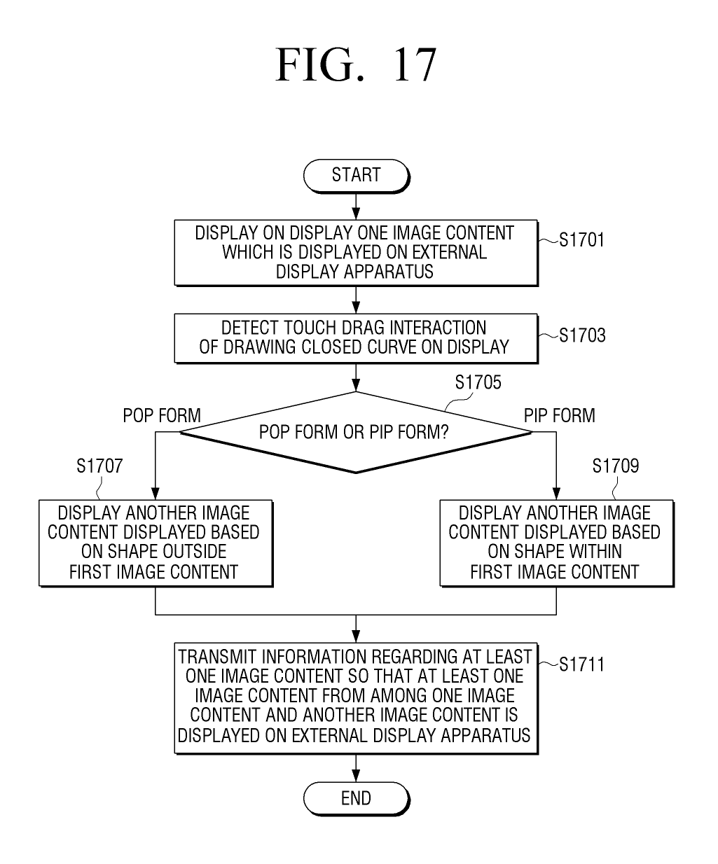

FIG. 17 is a flowchart illustrating a method through which the user terminal device 100 controls the display apparatus 200 according to another exemplary embodiment.

Referring to FIG. 17, the user terminal device 100 may display a first image content displayed on the display apparatus 200 (S1701). The user terminal device 100 may detect a touch drag interaction of drawing a shape on the display 110 (S1703). In response to the touch drag interaction, the user terminal device 100 may determine whether to display at least part of a second image content displayed based on the shape within a first image content in the form of PIP or outside the first image content in the form of POP (S1705). For example, in response to a new touch drag interaction, if the second image content moves and an edge of the second image content contacts one side of the display 110, the user terminal device 100 may display the second image content outside the first image content in the form of POP (S1707). On the other hand, if a new touch drag interaction is not detected within a predetermined time (for example, 1-2 seconds), the user terminal device 100 may display the second image content within the first image content in the form of PIP (S1709). Subsequently, the user terminal device 100 may transmit information regarding at least one image content so that at least one of the first image content and the second image content displayed on the display 110 of the user terminal device 100 is displayed on the display apparatus 200 (S1711).

The controlling method of a display apparatus according to the above-described various exemplary embodiments may be realized as a computer program and provided in the display apparatus. Specifically, a non-transitory computer readable medium storing a program including the controlling methods may be provided.

The non-transitory recordable medium refers to a medium storing data semi-permanently rather than storing data for a short time, such as a register, a cache, and a memory and may be readable by an apparatus. Specifically, the above-described various applications or programs may be stored in the non-transitory readable medium may be CD, DVD, hard disk, Blu-ray disk, USB, memory card, ROM, etc. and provided therein.

The foregoing embodiments and advantages are merely exemplary and are not to be construed as limiting the present inventive concept. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A user terminal device comprising:
a display configured to display at least one first image contents displayed on an external display apparatus;
a user interface configured to detect a user input on the display;
a controller configured to display at least one second image contents having different number of image contents from a number of the first image contents on the display in response to the user interface detecting the user input; and
a transceiver configured to transmit to the external display apparatus identification information identifying at least one of the second image contents to control the external display apparatus to display the at least one of the second image contents.

2. The user terminal device as claimed in claim 1, wherein the second image contents comprises the first image contents having a reduced size and at least one image content different from the first image contents.

3. The user terminal device as claimed in claim 1, wherein the user input comprises a touch drag interaction of touching one area of one image content from among the first image contents displayed on the display and dragging the touched area in one direction,
wherein in response to the touch drag interaction, the controller is further configured to control the display to display the one image content on a first side of a location of the touch drag interaction and display another image content different from the one image content on a second side of the location of the touch drag interaction.

4. The device as claimed in claim 1, wherein the user input comprises a pinch interaction on the display,
wherein in response to the pinch interaction being a pinch open interaction of widening a distance between fingers, the controller is further configured to control the display to display the second image contents, the second image contents being less in number than the first image contents, and
in response to the pinch interaction being a pinch close interaction of narrowing a distance between fingers, the controller is further configured to control the display to display the second image contents, the second image contents being greater in number than the first image contents.

5. The device as claimed in claim 1, wherein the user input comprises a touch drag interaction of touching an edge of one image content from among the first image contents displayed on the display and dragging the touched edge in one direction,
wherein in response to the touch drag interaction moving in a first direction, the controller is further configured to control the display to display the second image contents, the second image contents being less than in number than the first image contents, and
in response to the touch drag interaction moving in a second direction, the controller is further configured to control the display to display second image contents, the second image contents being greater in number than the first image contents.

6. The device as claimed in claim 1, wherein the user input comprises a touch drag interaction of drawing a shape on the display,
wherein the controller is further configured to control the display to display one image content and at least part of another image content within the shape on the display.

7. The device as claimed in claim 1, wherein the user input comprises a touch drag interaction of drawing a shape on the display,
wherein the controller is further configured to determine a location or a size of one image content based on a location or a size of the shape, and control the display to display another image content and the one image content of which location or size is determined on the display.

8. The device as claimed in claim 1, wherein the user input comprises a touch drag interaction of selecting at least one image content from among the second image contents and dragging the touched image content in a direction towards which the external display apparatus is located,
wherein the transceiver is further configured to transmit information regarding the selected at least one image content to the external display apparatus.

9. The device as claimed in claim 1, wherein the transceiver is further configured to transmit information identifying the at least one of the second plurality of image contents to a server configured to control the external display apparatus to display the at least one of the second plurality of image contents.

10. A multimedia system comprising:
a display apparatus comprising:
a display configured to display at least one first image contents; and
a transceiver configured to transmit the first image contents; and
a user terminal device comprising:
a transceiver configured to receive the first image contents from the display apparatus;
a display configured to display the first image contents received by the transceiver;
a user interface configured to detect a user input on the display of the user terminal device;
a controller configured to control the display of the user terminal device to display at least one second image contents having different number of image contents from the first image contents, in response to the user interface detecting the user input, wherein the transceiver is further configured to transmit to the display apparatus information identifying at least one image content of the second image contents to control the display apparatus to display the at least one image content of the second image contents on the display of the display apparatus.

11. A method for controlling an external display apparatus of a user terminal device, comprising:
displaying on a display of the user terminal device at least one first image contents displayed on a display of the external display apparatus;
detecting a user input on the display of the user terminal device;
displaying at least one second image contents having different number of image contents from a number of the first image contents on the display of the user terminal device, in response to detecting the user input on the display of the user terminal device; and
transmitting to the external display apparatus identification information identifying at least one image content of the second image contents to control the external display apparatus to display the at least one of the second image contents on the display of the external display apparatus.

12. The method as claimed in claim 11, wherein the second image contents comprises the first image contents having a reduced size and at least one image content different from the first image contents.

13. The method as claimed in claim 11, wherein the user input comprises a touch drag interaction of touching one area of one image content from among the first image contents displayed on the display and dragging the touched area in one direction,
wherein the displaying the second image contents comprises displaying the one image content on a first side of a location of the touch drag interaction and displaying another image content different from the one image content on a second side of the location of the touch drag interaction.

14. The method as claimed in claim 11, wherein the user input comprises a pinch interaction on the display,
wherein the displaying the second image contents comprises:
in response to the pinch interaction being a pinch open interaction of widening a distance between fingers, displaying the second image contents, the second image contents being less in number than the first image contents; and
in response to the pinch interaction being a pinch close interaction of narrowing a distance between fingers, displaying the second image contents, the second image contents being greater in number than the first image contents.

15. The method as claimed in claim 11, wherein the user input comprises a touch drag interaction of touching an edge of one image content from among the first image contents displayed on the display and dragging the touched edge in one direction,
wherein the displaying the second plurality of image contents comprises:
in response to the touch drag interaction in a first direction, displaying the second image contents, the second image contents being less than in number than the first image contents; and
in response to the touch drag interaction in a second direction, displaying the second image contents, the second image contents being greater in number than the first image contents.

16. The method as claimed in claim 11, wherein the user input comprises a touch drag interaction of drawing a shape on the display,
wherein the displaying second image contents comprises displaying one image content and at least part of another image content within the shape on the display.

17. The method as claimed in claim 11, wherein the user input comprises a touch drag interaction of drawing a shape curve on the display,
wherein the displaying the second image contents comprises:
determining a location or a size of one image content based on a location or a size of the shape; and
displaying another image content and the one image content of which location or size is determined on the display.

18. The method as claimed in claim 11, wherein the user input comprises a touch drag interaction of selecting at least one image content from among the second image contents and dragging the touched image content in a direction towards which the external display apparatus is located, and
wherein the transmitting comprises transmitting information regarding the selected at least one image content to the external display apparatus.

19. The method as claimed in claim 11, wherein the displaying the first image contents comprises receiving an image stream of the first image contents from the external display apparatus and displaying the first image contents based on the received image stream of the first image contents,
wherein the transmitting comprises transmitting information identifying the at least one of the second plurality of image contents to a server configured to control the external display apparatus to display the at least one of the second plurality of image contents.

20. A method for controlling a multimedia system comprising a display apparatus and a user terminal device, the method comprising:
displaying at least one first image contents on a display of the display apparatus;
transmitting the first image contents to the user terminal device;
receiving the first image contents from the display apparatus at the user terminal device;
displaying the first image contents on a display of the user terminal device;
detecting a user input on the display of the user terminal device;
displaying a second image contents having different number of image contents from a number of the first image contents on the display of the user terminal device;
transmitting to the display apparatus identification information identifying at least one image content of the second image contents ; and
displaying the at least one image content of the second image contents on the display of the display apparatus based on the identification information.

21. A portable terminal comprising:
a display;
a transceiver configured to receive a multiplexed stream of a plurality of image contents displayed on a display apparatus;
a controller configured to control the display to display the plurality of image contents;
a user interface configured to receive a user input configuring display of the plurality of image contents on the display,
wherein the controller is further configured to control the transceiver to transmit to the display apparatus configuration information indicating configuration of the plurality of image contents on the display to control the display apparatus to display the configured plurality of image contents on the display apparatus.

22. The portable terminal of claim 21, wherein the user input comprises a selection of a subset of the plurality of image contents, and
wherein the controller is further configured to control the transceiver to transmit the configuration information indicating the selection of the subset of the plurality of image contents to the display apparatus to control the display apparatus to display the subset of the plurality of image contents on the display apparatus.

23. The portable terminal of claim 21, wherein the user input comprises a
selection of a display size of the plurality of image contents, and
wherein the controller is further configured to control the transceiver to transmit the configuration information indicating the selection of the display size of the plurality of image contents to the display apparatus to control the display apparatus to display the plurality of image contents of the display size on the display apparatus.
